(19) United States
(12) Patent Application Publication
(10) Pub. No.: US 2025/0242242 A1
(43) Pub. Date: Jul. 31, 2025

(54) EGO-MACHINE SIMULATION USING HARDWARE IN-LOOP

(71) Applicant: NVIDIA Corporation, Santa Clara, CA (US)

(72) Inventors: Parag MEHENDALE, San Jose, CA (US); Issac Mark Rand Simha, San Jose, CA (US); Mingyang Zhao, San Jose, CA (US); Damien Fagnou, Montreal (CA); Suraj Das, Union City, CA (US); Ritaank Tiwari, Los Gatos, CA (US)

(21) Appl. No.: 18/422,694

(22) Filed: Jan. 25, 2024

(51) Int. Cl. A63F 13/5252; A63F 13/803

(52) U.S. Cl. CPC A63F 13/5252; A63F 13/803

(57) ABSTRACT

Embodiments of the present disclosure relate to hardware-in-loop (HIL) ego-machine simulation. In various examples, one or more real-world ego-machine hardware components are integrated with a simulated or emulated environment, such as a virtual digital twin ego-machine cockpit, for testing or other use cases. HIL ego-machine simulation may thus subject the one or more hardware components to simulated realistic data and interactions the hardware components would experience in its intended real-world operational environment. Therefore, various aspects involve the use of simulated functionality and real-world ego-machine hardware to create and/or update a virtual representation of an ego-machine that closely resembles its real-world counterpart, which improves the accuracy of simulation technologies.

### BACKGROUND

Vehicle simulation technologies are a critical part of the automotive industry. These technologies aim to replicate the behavior of real vehicles in a virtual environment, providing a cost-effective and safe way to evaluate and improve various aspects of automotive design and operation. Vehicle simulations are used for a wide range of purposes such as vehicle design, testing vehicle components, training, and conducting research on topics like autonomous driving. Simulations can help assess operator behavior, emergency response, and other critical factors without real-world risks and consequences.

One of the primary drawbacks of these and other technologies is that they may not accurately simulate real-world vehicles (or other ego-machines), real-world hardware components of the ego-machines, and/or real-world conditions. This may lead to inaccurate or otherwise unrealistic simulations, which, if propagated to real-world deployment, could contribute to unsafe driving conditions, thereby creating safety risks and a higher probability of accidents. For example, conventional simulation technologies fail to simulate how real-world lighting conditions (e.g., ambient light in a car) affect the display visibility of infotainment devices in cars. Consequently, a real-world driver may not be able to see a display screen of an infotainment device while driving because the display screen is not bright and there is a lot of ambient sunlight. Such display screen may contain important information, such as detected objects in the road or the like. Such simulation shortcoming and others described herein may thus severely limit or even interfere with a real-world ego machine operator's ability to safely navigate through an environment.

### SUMMARY

Embodiments of the present disclosure relate to ego-machine simulation that includes hardware-in-loop (HIL) elements. Accordingly, various embodiments may integrate one or more real-world ego-machine hardware components (e.g., In-Vehicle Infotainment (IVI) hardware) with a simulated or emulated environment (e.g., a digital twin of a cabin, cockpit, or other interior portion of an ego-machine) for testing or other use cases. HIL ego-machine simulation may thus subject the one or more hardware components to receive and process simulated realistic data (e.g., virtual sensor data) and interactions the hardware components would experience in its intended real-world operational environment. Therefore, various aspects involve the use of simulated functionality and real-world ego-machine hardware to create and/or update a virtual representation of an ego-machine that closely resembles its real-world counterpart, which improves the accuracy of simulation technologies.

Some embodiments specifically relate to causing display of display data in a virtual display device(s) of a virtual ego-machine based on a hardware component of a real-world ego-machine having generated the display data. In operation, particular embodiments receive simulation data that at least partially represents user input, one or more portions of an interior of a virtual ego-machine (that represents a real-world ego-machine), and/or one or more portions outside of the virtual ego-machine. In an illustrative example of the simulation data, various embodiments can employ scene authoring techniques to generate a virtual cockpit (e.g., a windshield, a steering wheel, and seats) and simulated ambient lighting in a virtual environment outside of the virtual ego-machine, as the virtual ego-machine traverses through the virtual environment. Responsive to the hardware component receiving such simulation data, it may produce the display data in the virtual display device(s). For example, in response to detecting a simulated ambient lighting condition exceeding a threshold, the hardware component may cause an automatic adjustment of the brightness level or generate corresponding simulated screen specularity (e.g., reflections) of a virtual area within a virtual display device. Such functionality may mimic the hardware component's functionality in its real-world environment.

In an illustrative example of the display data displayed at the virtual display device(s), the hardware component may generate real user interface features (e.g., digital avatars, buttons, etc.), real streaming service movie data, real video data of an environment that an ego-machine has traversed, VR/AR overlays (e.g., a pixel-wise segment and label of a “pedestrian”), or the like. Various embodiments may execute user input requests (e.g., touch screen simulations) by providing and modifying the display data at the virtual display device(s) via the use of the hardware component. Instead of displaying, for example, looping static virtual reality scene data to the virtual representation of the virtual display data, particular embodiments cause actual streamed video data frame-by-frame and/or other hardware data (e.g., real UI elements) within a virtual display area of the virtual display device(s) because an actual ego-machine hardware component (e.g., IVI hardware) is used in conjunction with the simulation data.

### BRIEF DESCRIPTION OF THE DRAWINGS

The present systems and methods for sensor simulation and learning sensor models with generative machine learning is described in detail below with reference to the attached drawing figures, wherein:

FIG. 1 is an example virtual ego-machine simulator system, in accordance with some embodiments of the present disclosure;

FIG. 2 is an example hardware system architecture for generating a virtual cockpit and data within one or more virtual display devices within the virtual cockpit, in accordance with some embodiments of the present disclosure;

FIG. 3 is a schematic diagram illustrating how a virtual cockpit of a virtual ego-machine may appear, in accordance with some embodiments of the present disclosure;

FIG. 4A is a schematic diagram illustrating how a virtual cockpit of a virtual ego-machine and respective virtual display devices may appear based on a natural lighting condition, in accordance with some embodiments of the present disclosure;

FIG. 4B is a schematic diagram illustrating how an appearance of the virtual cockpit of FIG. 4A changes based on a change to the natural lighting condition of FIG. 4A and/or an introduced lighting condition based on a virtual light, in accordance with some embodiments of the present disclosure;

FIG. 5 is a flow diagram of an example process for causing display of display data in one or more virtual display devices of a virtual ego-machine, in accordance with some embodiments of the present disclosure;

FIG. 6 is a flow diagram of an example process or displaying one or more portions of a virtual cockpit, in accordance with some embodiments of the present disclosure;

FIG. 7 is a flow diagram of an example process for generating and modifying a mode of an interior design of an ego-machine, in accordance with some embodiments of the present disclosure;

FIGS. 8A-8F are example illustrations of a simulation system, in accordance with some embodiments of the present disclosure;

FIG. 9 is a flow diagram showing a method for generating a simulated environment using a hardware-in-the-loop (HIL) object, in accordance with some embodiments of the present disclosure;

FIG. 10A is an example illustration of a simulation system at runtime, in accordance with some embodiments of the present disclosure;

FIG. 10B includes a cloud-based architecture for a simulation system, in accordance with some embodiment of the present disclosure;

FIG. 11 includes a data flow diagram illustrating a process for re-simulation or simulation using one or more codecs, in accordance with some embodiments of the present disclosure;

FIG. 12 includes a data flow diagram for key performance indicator (KPI) analysis and observation, in accordance with some embodiments of the present disclosure;

FIG. 13A is an illustration of an example autonomous vehicle, in accordance with some embodiments of the present disclosure;

FIG. 13B is an example of camera locations and fields of view for the example autonomous vehicle of FIG. 13A, in accordance with some embodiments of the present disclosure;

FIG. 13C is a block diagram of an example system architecture for the example autonomous vehicle of FIG. 13A, in accordance with some embodiments of the present disclosure;

FIG. 13D is a system diagram for communication between cloud-based server(s) and the example autonomous vehicle of FIG. 13A, in accordance with some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

Some embodiments relate to causing display of display data in a virtual representation of virtual display device(s) of a virtual ego-machine based on a hardware component of a real-world ego-machine having generated the display data. In operation, particular embodiments first receive simulation data that at least partially represents one or more portions of an interior of a virtual ego-machine that is a virtual representation of a real-world ego-machine. For example, various embodiments can employ scene authoring techniques to generate a virtual interior portion of an ego-machine, which includes a windshield, a steering wheel, seats, an infotainment device, and/or a rear-view mirror as the virtual ego-machine traverses through a virtual environment. Scene authoring may include, modeling, texturing, shading, lighting, animation, and/or simulation. Modeling is the process of creating 3D objects, structures, characters, and other assets that populate a driving scene or other simulation data (e.g., via the use of 3D modeling functionality, such as BLENDER). Texturing and Shading includes applying textures and materials (e.g., albedo material maps) to the 3D models to give them realistic appearances. This can include things like applying textures, and defining how materials react to light (e.g., via a Spatially-varying Bidirectional Reflectance Distribution Function (SVBRDF)). A Bidirectional Distribution Function (BRDF) is a function used to describe the reflectance properties of a real world object surface (or how light interacts with a surface). “Spatially-varying” BRDF means that reflectance properties change across a surface depending on the position of the corresponding object in relation to a light source, which affects the lighting (e.g., intensity, absorption, or scattering), the color of the object, the texture of the object, or other geometric features of the object (e.g., roughness, glossiness, etc.).

In an illustrative example of scene authoring, it can be utilized to generate one or more virtual display devices simulating one or more real-world display devices as a virtual ego-machine traverses through an environment. For instance, scene authoring techniques can generate a digital twin of an infotainment device located in a digital center console of a virtual ego-machine. In the context of simulation, a digital twin typically refers to a highly detailed and realistic digital representation of a real-world ego-machine, its real-world components, and/or real-world conditions (e.g., lighting) by collecting and integrating data from one or more sources, such as sensors, IoT devices, and other data streams, to create a detailed and dynamic digital model. This digital model may mimic one or many real-world ego machine characteristics, behavior, and attributes in real time or near-real-time as the virtual ego-machine traverses through an environment.

Some embodiments may receive first display data generated by the hardware component of the real-world ego-machine. For example, such hardware component can be “In-Vehicle Infotainment hardware” (IVI). IVI refers to the electronic hardware components and systems installed in vehicles to provide entertainment, information, connectivity, and/or navigation features to both drivers and passengers. IVI systems may be found in modern automobiles and may be a central part of the vehicle's dashboard or center console. Accordingly, the IVI may generate, for example, real user interface features (e.g., app avatars, buttons, etc.), real video data, VR/AR overlays (e.g., a pixel-wise segment and label of a “pedestrian”), or the like as at least a portion of the first display data. Based on the receiving of the first display data generated by the hardware component of the real-world ego-machine, various embodiments cause display of the first display data in the virtual representation at the virtual display device(s) of the virtual ego-machine. Accordingly, for example, instead of displaying looping static virtual reality scene data to the virtual representation of the virtual display data, particular embodiments cause actual streamed video data frame-by-frame within the virtual representation of the virtual display area.

In some embodiments, the simulation data may be representative of a user interface design tool for real-world display device(s) of the real-world ego-machine or an ego-machine design tool to design one or more portions of an interior portion of the real-world ego-machine. Automotive designers and engineers are faced with a challenge setting of integrating their software and/or design decisions into a vehicle that has not been built yet. For example, an engineer working on a user interface (e.g., main launcher, different apps) cannot see how the user interface will look in the real car environment. Factors to consider may be: how an app will look from different seats in the car, with a specific screen and/or text size, whether the colors and/or brightness in the user interface suit the lighting in the car well, whether there should be different color or brightness schemes for different times of day, or the like.

In an illustrative example of a user interface design tool, the simulation data may include a representation of natural lighting (e.g., sunlight) characteristics (e.g., SVBRDF light absorption and scattering) outside of the virtual ego-machine and/or lighting characteristics according to a placement of a virtual source of illumination within the interior of the virtual machine (e.g., a specific orientation of shadow representations based on placement of a virtual overhead light). In this way, the display, at the virtual display device(s) of the virtual ego-machine, of the first display data, is based at least in part on the representation of the natural lighting characteristic. For instance, an engineer may test automatic brightness adjustments of displayed data in response to detection of a change in ambient lighting as the virtual ego-machine traverses through the environment over a time period.

Some embodiments trigger a hardware component to generate real-world video data based on processing virtual sensor data. In these embodiments, the simulation data may include a representation of a scene configuration outside of the virtual ego-machine. For example, the simulation data may be different objects in a simulated environment, such as VR pedestrians, VR buildings, VR street signs, VR traffic lights, and/or the like. Particular embodiments predict virtual sensor data representative of portion(s) outside of the virtual ego-machine based on the representation of the scene configuration. For example, a virtual radar, LiDAR, and/or camera or other virtual sensor may detect, via segmentation or a bounding box, a pedestrian. Then, such simulation data may transmitted, e.g., over a network, to a network device (e.g., an I/O server), which translates the simulation data into real-world sensor (e.g., real world radar, LiDAR, and/or camera inputs) data. This triggers the hardware component to generate real-world video data based at least on processing the virtual sensor data. In this way, the display, at the virtual display device(s) of the virtual ego-machine, of the first display data, includes the real-world video data based at least on the prediction of the virtual sensor data. For example, the real-world video data may include multiple frames or images representing a video sequence with VR overlays, such as a street sign, which may be embedded into the texture of the virtual display device(s).

Some embodiments trigger the hardware component to cause display, at the virtual display device(s), of the first display data based on receiving a user input at the virtual display device(s) and interpreting such user input as a touch input. For example, a user may engage in an actual real-world mouse pointer click at an LCD screen at a user device and the actual location of the click may be within a virtual app icon of the virtual display device(s). Responsively, particular embodiments may inject a command into a test port at the hardware component. Such command may include the coordinates (e.g., X and Y coordinates) that indicate where the click occurred, which effectively maps the click location into a corresponding input location that the hardware component receives and interprets as a touch input. In other words, a command from simulation system is being sent to a specific connection point at the real-world ego-machine's control system. In this way, the hardware component processes the click as if it were a real-world touch input, even though it was a simulated touch input (a mouse click). Continuing with this example, this triggers the hardware component to cause display, at the one or more virtual display devices, of a page (the first display data) of the app, which has been opened based at least on the receiving of the mouse click at the simulated app within the virtual display device(s) and interpreting the user input as a touch input.

Some embodiments trigger the hardware component to cause display, at the virtual display device(s), of a video game feed in response receiving user input made at a video game controller. For example, a user may push a real-world joystick in a right direction, which represents a simulated input that a user makes in the backseat of the virtual ego-machine to play a game at the virtual display device(s). Responsively, particular embodiments may inject a command into a test port at the hardware component. Such command may include a request to map the right joystick input into a corresponding hardware component input. In this way, the hardware component processes the joystick right direction input as if it were a real-world input. Continuing with this example, this triggers the hardware component to cause display, at the virtual display device(s), of a video game character moving in a right direction in the video game feed based on the real-world joystick movement in the right direction at the video game controller.

Some embodiments modify or control, at the virtual display device(s) of the virtual ego-machine, a size, a location, a resolution, screen reflectivity, or a brightness level of the first display data in the virtual representation of the real-world ego machine based on a display capability of the hardware component, a representation of a natural lighting characteristic outside of the virtual ego-machine, a user input at the one or more virtual display devices, and/or a representation of a lighting characteristic according to a placement of a virtual source of illumination within the interior of the virtual ego-machine. Examples of display capabilities of the hardware component are display capabilities of an IVI device (corresponding to an infotainment device), such as screen size, resolution, touchscreen functionality, multi-touch support, brightness, color depth, and the like. For example, car infotainment systems typically have touchscreens with various sizes, ranging from around 5 inches to over 10 inches. Such screen size may therefore define the visible surface of the virtual display device(s). Further, many modern car infotainment displays have resolutions in the range of 720p (HD) to 1080p (Full HD) or higher, which can be represented in the virtual display device(s). Some infotainment displays support multi-touch gestures, enabling users to perform complex touch interactions, such as two-finger zooming on maps. Accordingly, in response to performing such action at the virtual display device(s), such input triggers the IVI hardware to zoom in at the virtual display device(s). Car infotainment screens should be visible in various lighting conditions, so they often have adjustable brightness levels and anti-glare coatings to reduce reflections, which can, for example, automatically adjust based lighting conditions. As described herein, in some embodiments, the simulation data includes a representation of a lighting characteristic such that the brightness level or anti-glare coatings can be automatically modified according to the simulated lighting characteristic in near real-time (e.g., as the simulated sun rises and falls).

In some embodiments the simulation data is accessible via one or more augmented or virtual reality devices associated with one or more teams of designers or developers. In this way, such designers or developers may collaborate or remotely access the simulation data via such devices. For example, in some embodiments the simulation data is part of a platform (e.g., OMNIVERSE from NVIDIA Corporation) that enables collaborative 3D content creation, simulation, and design across various industries. Collaboration may be facilitated through a range of features and tools that allow teams to work together in a shared virtual environment. For example, some features of such platform may be a shared virtual environment. A shared virtual environment is an environment where multiple team members can collaborate on 3D projects (e.g., a virtual portion of an inside portion of a virtual ego-machine) in real-time. In some embodiments, such platform enables real-time collaboration, allowing team members to work together simultaneously on the same project. This means that changes made by one team member are immediately visible to others. For example, if one team adjusts the placement of a virtual light in location Y, such change will be immediately available to other teams. In some embodiments, teams may easily share 3D assets, models, textures, and materials within the platform. In some embodiments, assets may be stored in a central library, making them readily accessible to all collaborators. This streamlines asset management and ensures consistency across projects. In some embodiments, such platform offers version control capabilities, allowing teams to keep track of changes and revisions to their 3D scenes and assets. This ensures that team members can easily review and revert to previous versions if necessary. In some embodiments, the platform is extensible, allowing developers to create custom extensions and plugins to enhance the platform's functionality, tailor it to specific project needs, or integrate with other tools.

### Example Virtual Ego-Machine Simulator System

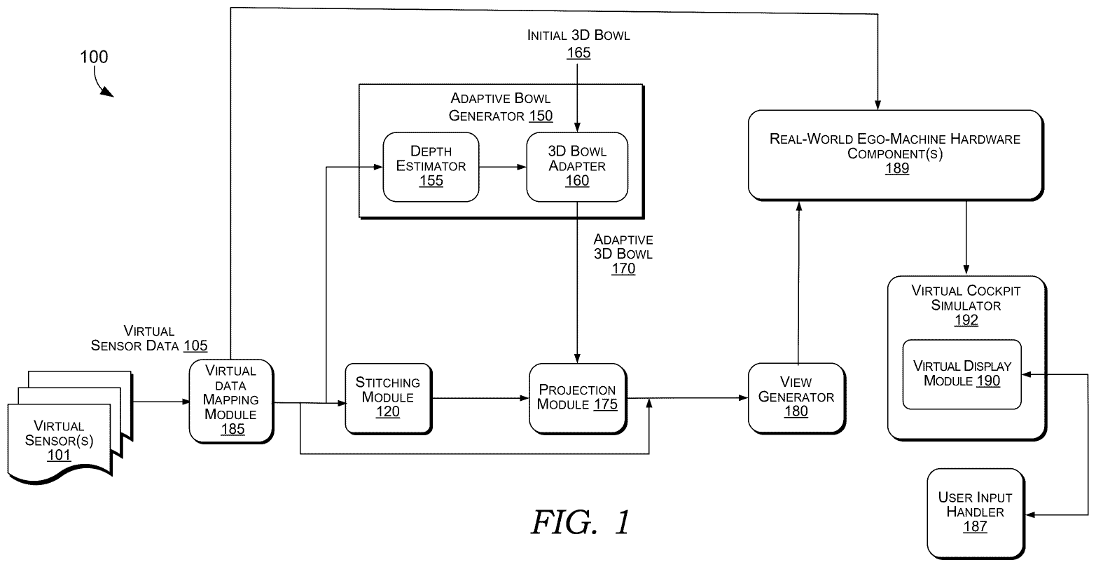

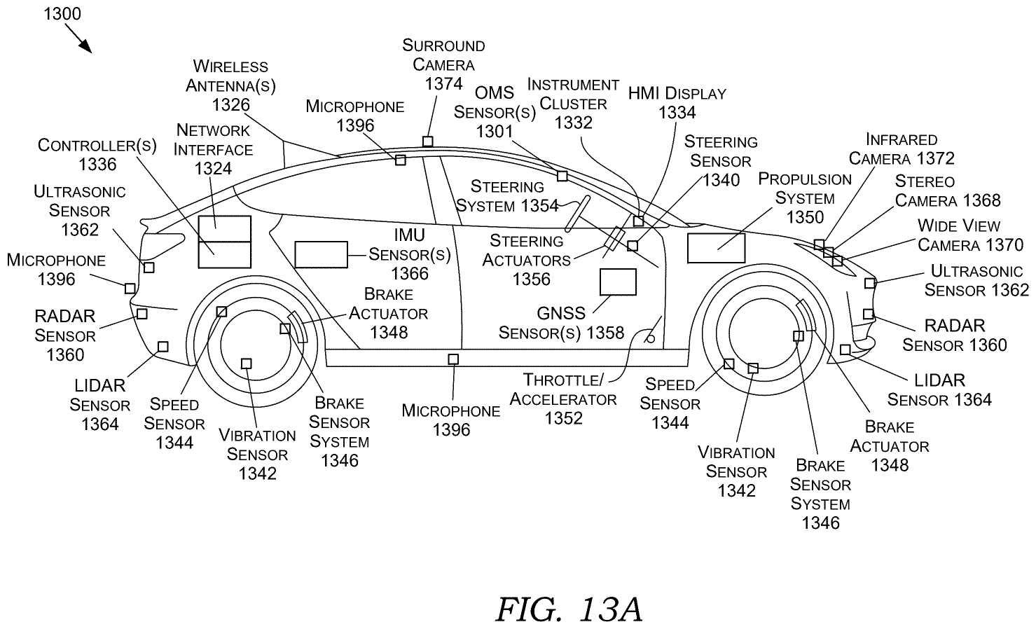

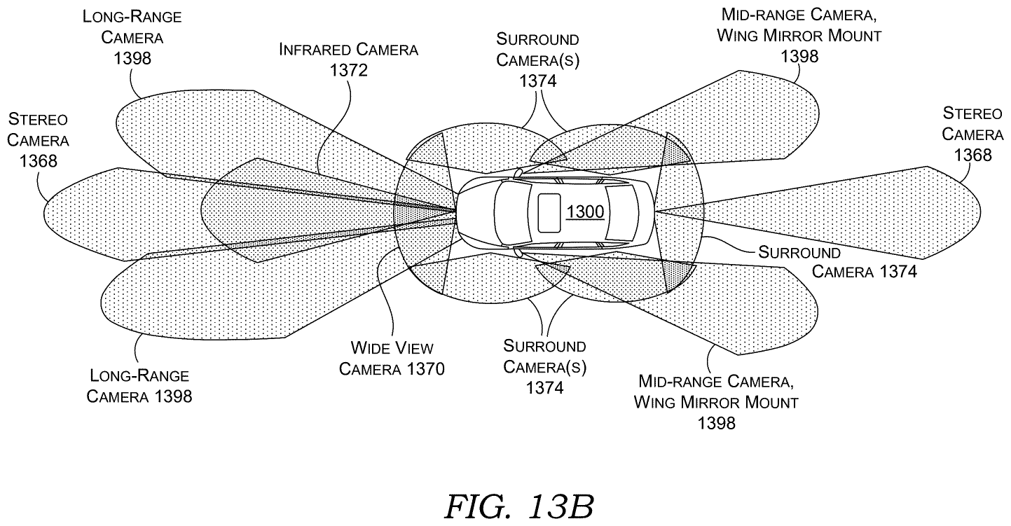

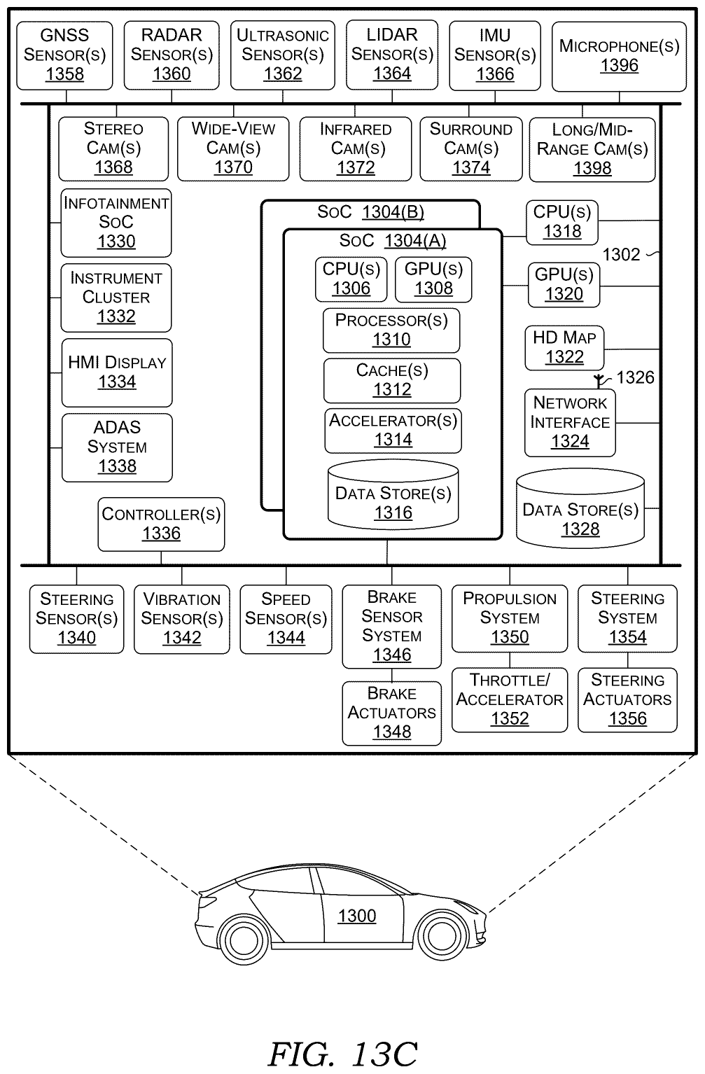

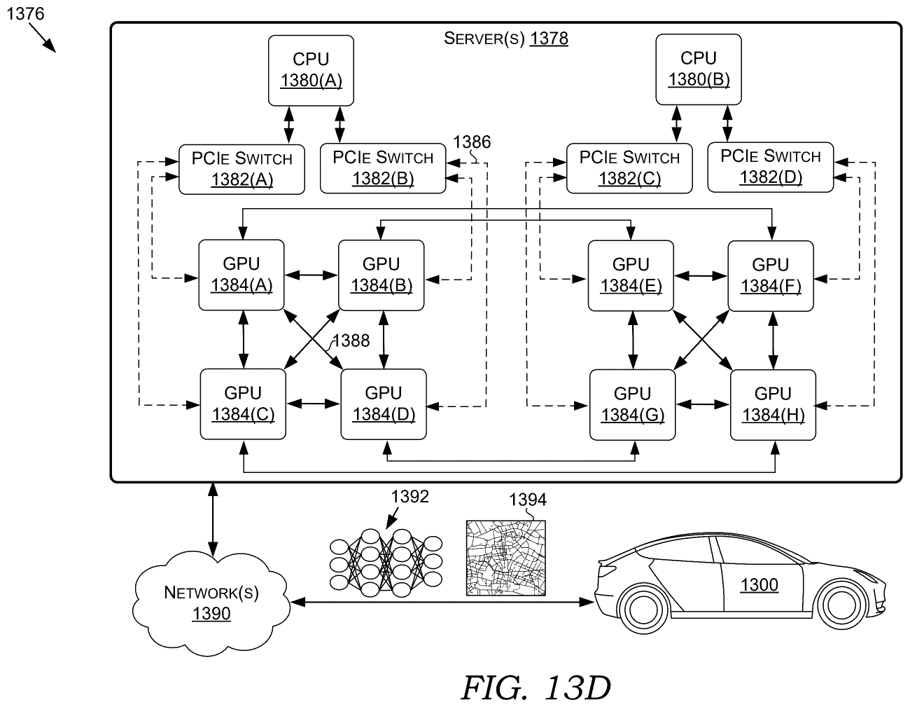

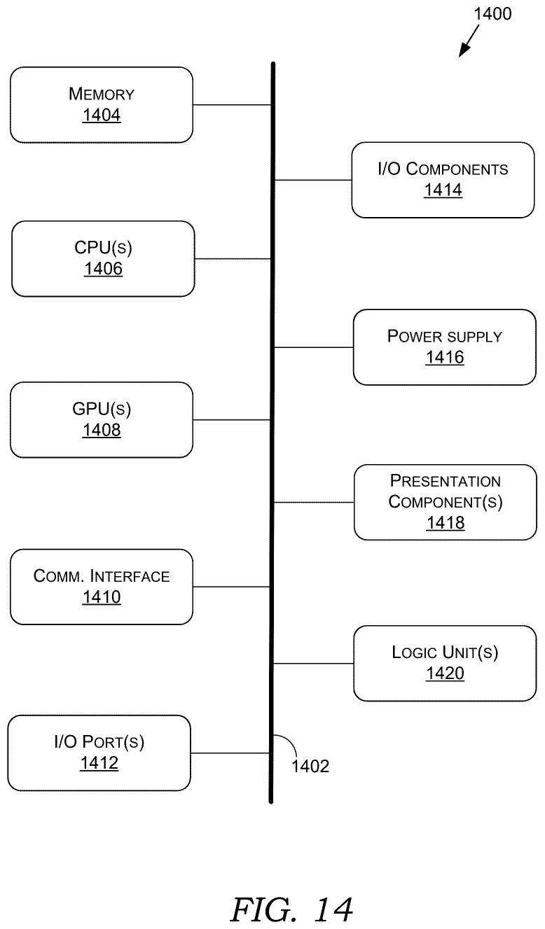

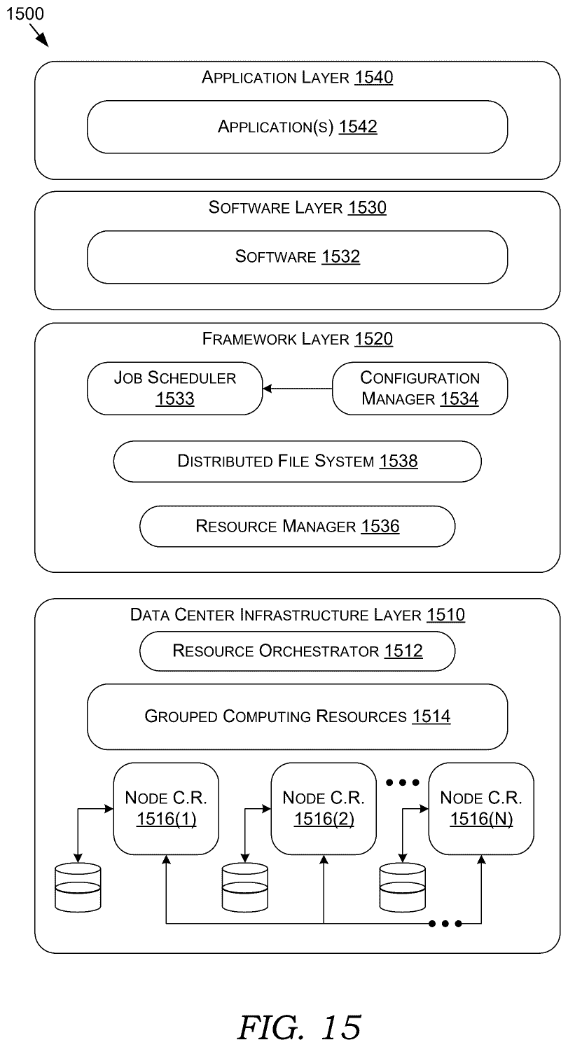

With reference to FIG. 1, FIG. 1 is an example virtual ego-machine simulator system 100 (referred to as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1300 of FIGS. 13A-13D, example computing device 1400 of FIG. 14, and/or example data center 1500 of FIG. 15.

As a high level overview, the system 100 may create a digital twin of an interior space such as a cockpit or cabin of an ego-machine, such as the autonomous vehicle 1300 of FIGS. 13A-13D, and may include one or more physical or simulated components of the ego-machine. In The system 100 includes an adaptive bowl generator 150, a stitching module 120, a projection module 175, a view generator 180, a virtual data mapping module 185, one or more real-world ego machine hardware components 189, a user input handler 187, and/or a virtual cockpit simulator 192.

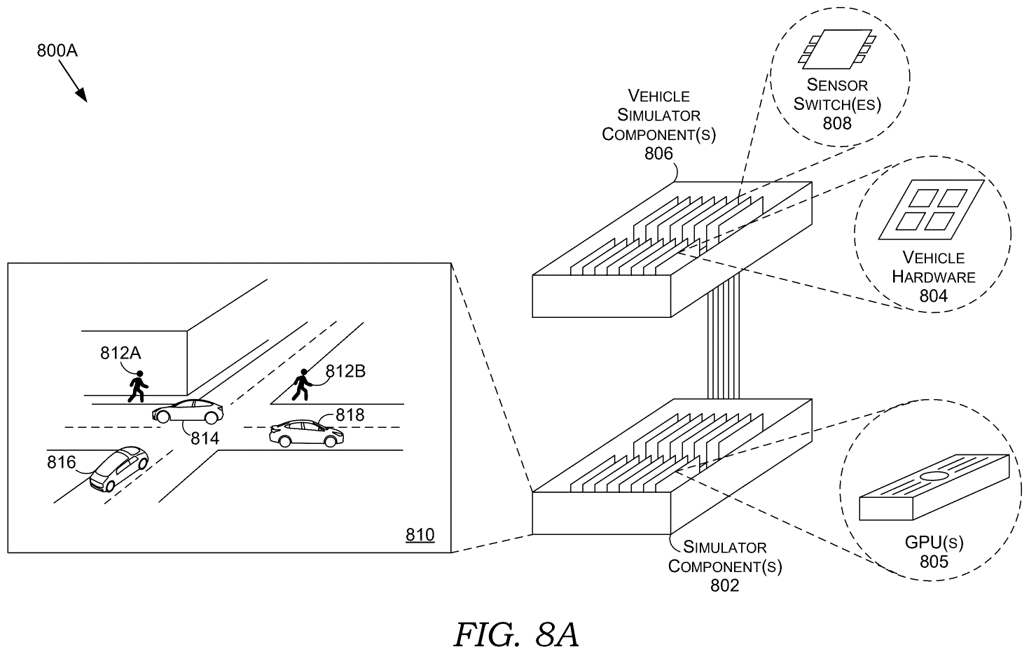

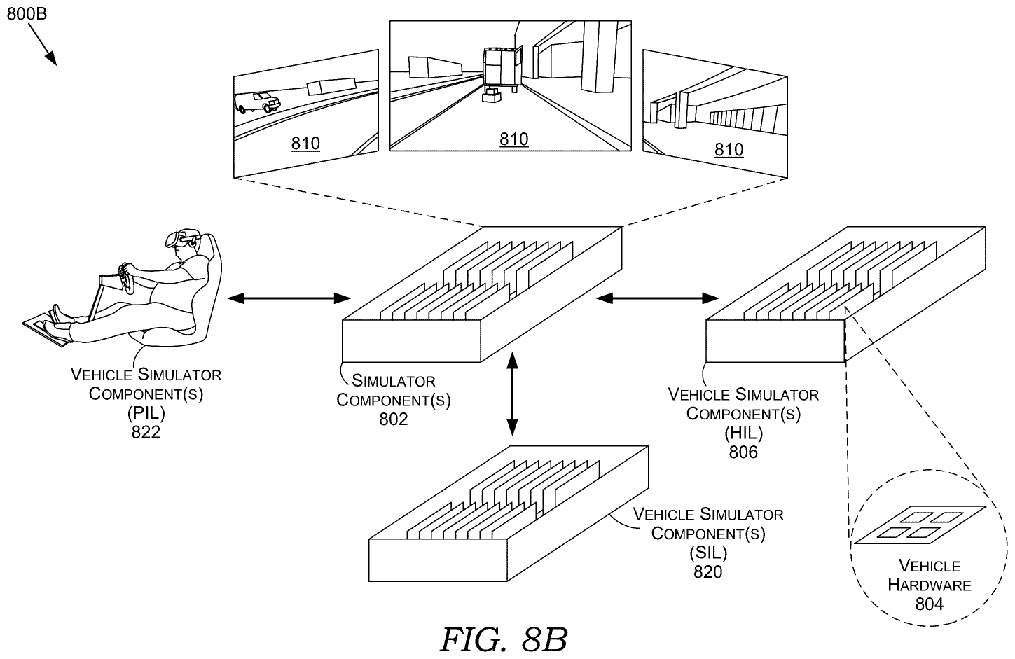

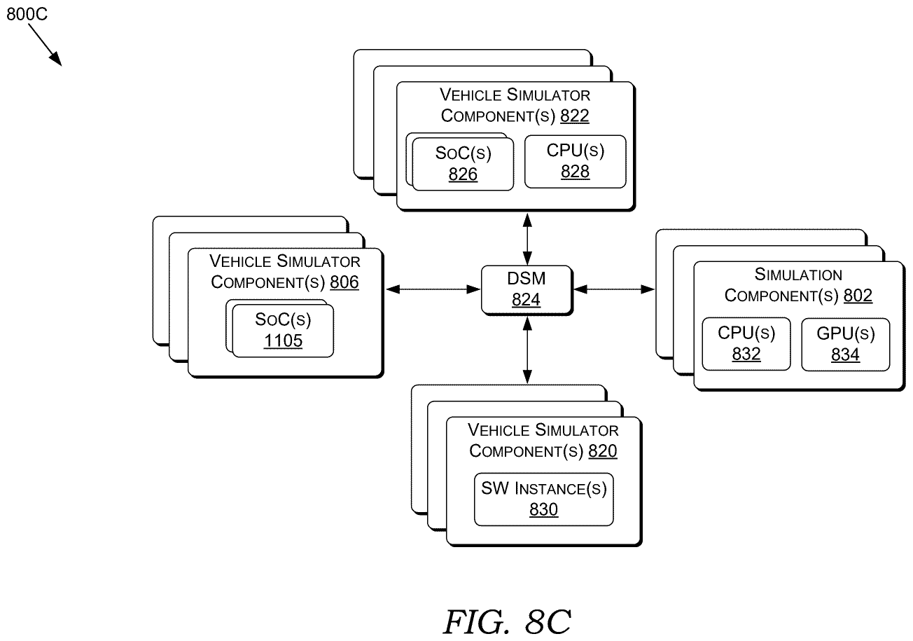

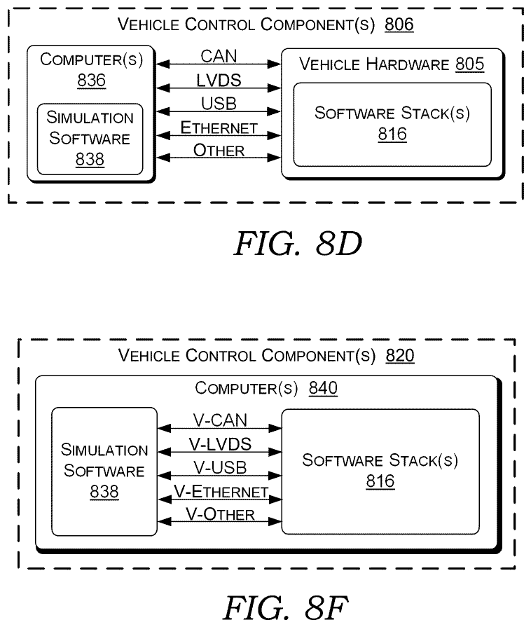

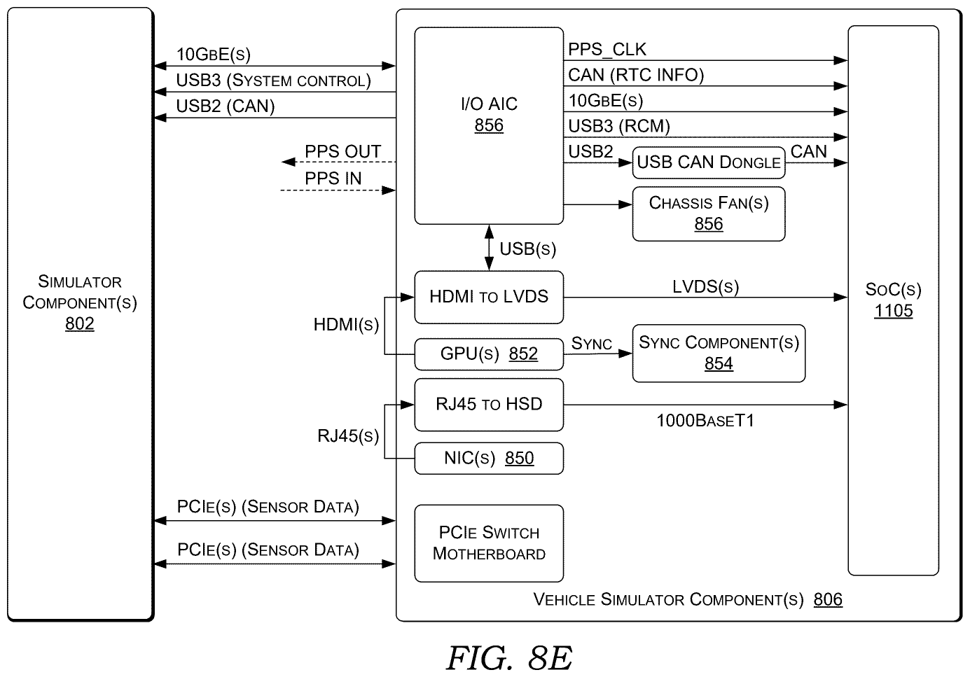

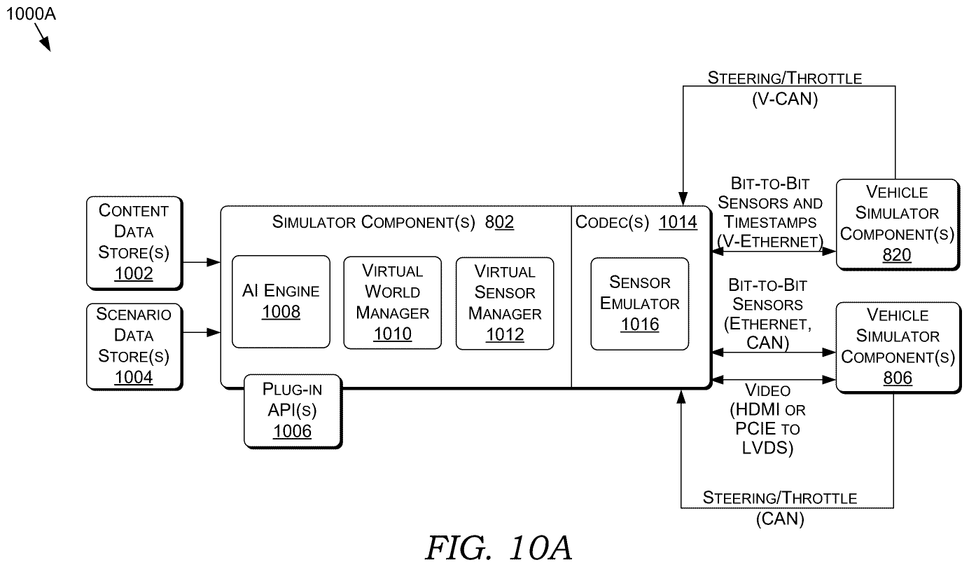

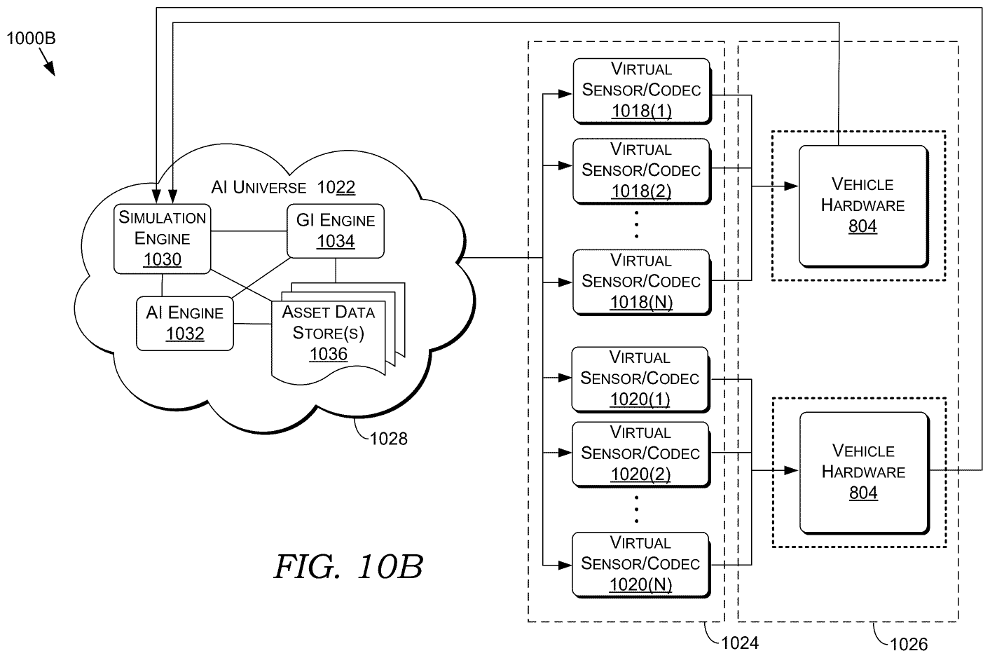

FIG. 1 illustrates an embodiment in which the ego-machine uses any number and type of virtual (and/or physical) sensor(s) 101 such as one or more virtual cameras that capture virtual sensor data 105 representing the surrounding environment to generate a (e.g., surround view) visualization representing the surrounding environment, and the (e.g., surround view) visualization may be streamed into a texture representing a screen of a virtual display device (e.g., via the virtual display module 190) within a virtual ego-machine that simulates a corresponding physical display device in the physical ego-machine. In some embodiments, the virtual sensor(s) 101 and corresponding virtual sensor data 105 are generated and used as described in FIG. 8A through 8C, and FIG. 10.

In an example embodiment involving streaming a surround view visualization into a simulated environment, a virtual ego-machine is equipped with any number and type of virtual sensor(s) 101 (e.g., one or more cameras, such as fisheye cameras), and the virtual sensor(s) 101 may be used to generate frames of (e.g., overlapping) sensor data (e.g., overlapping image data) for each time slice. Generally, any suitable virtual and/or physical sensor may be used, such as one or more of the stereo camera(s) 1368 (or its virtual representation), wide-view camera(s) 1370 (e.g., fisheye cameras or its virtual representation), infrared camera(s) 1372 (or its virtual representation), surround camera(s) 1374 (e.g., 360° cameras or its virtual representation), and/or long-range and/or mid-range camera(s) 1398, of the vehicle 1300 of FIG. 13A. Typically, different sensors have their own 3D coordinate systems. As such, some embodiments align sensor data from the sensor(s) 101 (e.g., image data) in a coordinate system defined relative to the ego-object, such as a vehicle rig coordinate system. Additionally or alternatively, the environment surrounding the ego-object may be modeled in a global 3D coordinate system (world space), and the sensor data may be aligned in the global 3D coordinate system. In an example configuration, four virtual fisheye cameras are installed at the front, left, rear and right side of a virtual vehicle, where surrounding videos are continuously captured. Ego-motion of the virtual vehicle may be generated using any known technique and synchronized with timestamps of the frames (e.g., images) of the videos. For example, absolute or relative ego-motion data (e.g., location, orientation, positional and rotational velocity, positional and rotational acceleration) may be determined using a virtual vehicle speed sensor, gyroscope, accelerator, inertial measurement unit (IMU), and/or others.

The virtual data mapping module 185 is generally responsible for mapping (e.g., translating) the virtual sensor data from the sensor(s) 101 into real-world sensor data inputs that the real-world ego-machine hardware component(s) 189 and/or the rest of the system 100 is capable of processing. This mapping process ensures that the simulated data closely resembles the real sensor data input in terms of structure and content. In an illustrative example, if the virtual sensor data 105 uses a different coordinate system, units of measurement, or data format relative to the real-world ego-machine hardware component(s) 189, various embodiments convert this simulated data into a format that matches the real sensor data coordinate system, units of measurement, or data format that can be processed by the real-world ego-machine hardware component(s) 189. Further, synchronization in time may be useful to ensure that the simulated sensor data aligns with the real sensor data as closely as possible. The virtual sensor data may thus be matched with the real data in terms of timing and temporal aspects.

Time synchronization, for example, involves making sure that the virtual sensor data is generated and/or transmitted at the same time intervals as the real sensor data is sampled and received. This helps maintain consistency and allows for meaningful comparisons between the two datasets. Synchronization in space refers to aligning the spatial or positional aspects of the virtual and real sensor data. In various embodiments, the virtual sensor data 105 is transformed and adjusted spatially to match the relative positions and orientations of the real-world sensors. Calibration involves adjusting the virtual sensor models within the simulated environment to match the characteristics and behaviors of the real sensors or real-world ego-machine hardware component 189 as closely as possible. This may include adjusting parameters related to sensor resolution, field of view, noise, distortion, range, and other performance factors.

In an illustrative example, with respect to virtual sensor data, a virtual LiDAR may generate a simulated LiDAR sensor model that generates simulated point cloud data representing the surroundings of a virtual ego-machine (e.g., a vehicle). Real LiDAR sensors, however, might have slightly different characteristics compared to the simulated model. This could include variations in the number of laser beams, beam angular resolution, measurement noise, and even the coordinate system used to express the point cloud data. Data translation or mapping may be useful to bridge the gap between the simulated LiDAR sensor data and real LiDAR sensor data.

For example, the simulated LiDAR model may generate point cloud data in a local coordinate system defined by the virtual environment. Real LiDAR sensors may have their own coordinate system, which may be based on the vehicle's frame of reference. Data translation or mapping functionality may, for example, transform the simulated point cloud data from the simulate environment's coordinate system to match the real LiDAR's coordinate system. This transformation includes adjusting for the vehicle's position, orientation, and orientation angles.

In another example, simulated data may use different units of measurement for distances, such as meters, while real LiDAR sensors might use millimeters or centimeters, for example. Data translation or mapping can additionally or alternatively thus involve scaling the simulated data to match the units of measurement used by the real sensors. Simulated data may also lack certain noise and artifacts that are present in real LiDAR data. In the translation process, particular embodiments may introduce or modify noise to the simulated data to mimic the real-world sensor's noise characteristics.

In yet another example, real LiDAR sensors may have specific beam properties, such as beam divergence, angular resolution, and measurement accuracy. Simulated data may be adjusted to account for these properties. Data translation or mapping may therefore involve modifying the simulated data to include the realistic beam characteristics of the real LiDAR sensor.

In some embodiments, system 100 models the surrounding environment using a 3D shape such as a 3D bowl and projects image data (e.g., the stitched image) onto the 3D bowl to generate a surround view visualization. In some embodiments, the 3D bowl has an adaptive shape that depends on distance(s) and/or direction(s) to detected object(s). For example, the adaptive 3D bowl generator 150 may use sensor data from the one or more sensor(s) 101 to generate an adaptive 3D bowl 170 that models the environment with a shape that depends on distance and/or direction to detected objects in the environment. For example, the adaptive 3D bowl generator 150 may include a depth estimator 155 that estimates distance and/or direction to detected object(s) in the environment (e.g., e.g., using 3D objection detection, using a projection of sensor data onto a top-down 2D occupancy grid), and a 3D bowl adapter 160 may fit a shape for the adaptive 3D bowl 170 (e.g., by deforming an initial 3D bowl 165) based on the distance(s) and/or direction(s) to detected object(s).

The projection module 175 may project the stitched image generated by the stitching module 120 to generate a projection image (e.g., a top-down projection image) using estimated depth values (e.g., generated by the depth estimator 155), depth values sampled from a fixed 3D bowl, depth values sampled from the adaptive 3D bowl 170, and/or otherwise. Additionally or alternatively, the projection module 175 may map the stitched image generated by the stitching module 120 (or corresponding virtual sensor data 105 or dewarped image data) onto a fixed 3D bowl, the adaptive 3D bowl 170, or some other 3D representation of the surrounding environment to generate a textured 3D model of the environment (e.g., a textured 3D bowl).

With respect to the stitching module 120, approaches in accordance with various embodiments provide for the generation, editing, or manipulation of image or video data. In particular, various embodiments provide for the generation of composite image or video data, using a system and methodology for combining (e.g., stitching) discrete image data into contiguous, composite surround or panoramic views. This may include, for example and without limitation, stitching individual frames captured using multiple sensors in an environment with at least partially overlapping fields of view such that each frame provides a larger field of view than is captured in any individual frame of the frames to be stitched together, such as a 180° or 360° view. At least some of the pixels may have their color values blended during the stitching or compositing process.

Stitched or composite image data generated, via the stitching module 120, using such a process may be utilized for various purposes. It should be understood that, at least for convenience of explanation, “image” data may be referred to herein, although image data may take many different forms, such as where individual images correspond to individual frames of video, or where image data is used to generate immersive video, augmented reality (AR), virtual reality (VR), or mixed reality (MR) experiences. In one example use case, live video data may be captured for a device or system such as a robot, or (autonomous or semi-autonomous) vehicle (collectively, an ego-vehicle). It may be desirable to combine the live video data from multiple cameras to generate a consistent view of the environment, such as a full view of the environment surrounding around that device or machine, which may be presented to an operator, monitoring system, occupant or passenger, remote viewer, or other such entity. For many of these systems, it may be helpful to generate such composite video representations in real time, such that an operator or monitoring system can take actions, if needed, based on real time observations.

The view generator 180 may output an image, such as a 2D image. For example, some embodiments may position and orient a virtual camera (e.g., the senor(s) 101) in a 3D scene with the textured 3D bowl and the view generator 180 render a view of the textured 3D bowl from the perspective of the virtual camera through a corresponding viewport. In some embodiments, the viewport may be selected based on a driving scenario (e.g., orienting the viewport in the direction of ego-motion), based on a detected salient event (e.g., orienting the viewport toward the detected salient event), based on an in-cabin command (e.g., orienting the viewport in a direction instructed by a command issued by an operator or occupant of the physical or virtual ego-object), based on a remote command (orienting the viewport in a direction instructed by a remote command), and/or otherwise. As such, the view generator 180 may output a visualization (e.g., a surround view visualization) of the surrounding environment. In some embodiments, the view generator 180 produces, at its output, a 2D or 3D representation of a physical (e.g., driving or navigational) environment with a digital twin or other virtual representation of one or more ego-objects in the physical environment.

The real-world ego-machine hardware component(s) 189 is generally responsible for taking the sensor data inputs (e.g., LiDAR laser pulses) translated from the virtual data mapping module 185 and/or the image produced by the view generator 180, processing such inputs (e.g., generating a LiDAR point cloud), and responsively instructing the virtual cockpit simulator 192 to generate a virtual cockpit and/or data within a virtual display device of the virtual cockpit based on the processing of the sensor data inputs. The real-world ego-machine hardware component(s) 189 may be one or more real-world hardware components of a real-world ego-machine. Such hardware components are capable of controlling one or more real-world devices of a real-world ego-machine. For example, in some embodiments, the real-world ego-machine hardware component(s) 189 includes an in-vehicle Infotainment hardware (IVI), which is capable of controlling a real-world infotainment device of a real-world ego-machine. That is, if the IVI hardware was placed in a real-world vehicle, it may be configured (e.g., via wiring) and programmed to control one or more infotainment devices in such real-world ego-machine.

In another example, the real-world ego-machine hardware component(s) may additionally or alternatively include a cockpit electronic control unit (ECU). A cockpit ECU is a component in modern automotive and/or aerospace systems. It refers to an electronic control unit or computer system that manages and controls various functions within the cockpit or operator's area of a vehicle or aircraft. These functions may vary depending on the specific application may include: instrument cluster, infotainment system, climate control, driver assistance systems, lighting controls, steering wheel controls, safety systems, and/or maintenance functions. In an illustrative example, the cockpit ECU may control and cause display (e.g., at a virtual display device) information such as vehicle speed, engine RPM, fuel level, sensor maps (e.g., LiDAR and RADAR objects including pedestrians and street signs), a real-world video representation of the adaptive 3D bowl 170, and/or warning lights on an instrument cluster. The cockpit ECU may manage the infotainment system, including audio and video playback, navigation, smartphone integration, and connectivity features. Further, in vehicles, the cockpit ECU may additionally or alternatively control the heating, ventilation, and air conditioning (HVAC) system to maintain a comfortable cabin temperature. The cockpit ECU may additionally or alternatively control advanced driver assistance systems (ADAS) like adaptive cruise control, lane-keeping assist, and collision avoidance systems. Cockpit ECUs may additionally or alternatively manage the interior and exterior lighting systems, including headlights, taillights, interior lighting, and ambient lighting.

In some embodiments, cockpit ECUs may additionally or alternatively manage buttons and controls on the steering wheel, allowing the driver to interact with various vehicle functions without taking their hands off the wheel. In aircraft, cockpit ECUs may manage critical flight control systems, including autopilot, navigation, and communication systems. Cockpit ECUs may additionally or alternatively monitor the health of various vehicle systems and provide diagnostic information to help with maintenance and troubleshooting. Cockpit ECUs may thus help integrate and control various subsystems, making it easier for drivers and/or pilots to operate and interact with the vehicle or aircraft. In some embodiments, the real-world ego-machine hardware component(s) 189 additionally or alternatively include one or more real-world sensors, such as the real-world LiDARS described herein, or any other suitable sensor (e.g., radar, camera, accelerometer, gyroscope, GPS, etc.).

In an illustrative example, the sensor(s) 101 may provide sensor data, such as a quantity of virtual laser pulses, angular resolution, and the time it takes for the laser pulses to travel from the virtual LiDAR to the virtual object and back. The virtual data mapping module 185 then converts such quantity of virtual laser beams and angular resolution to the quantity laser beams the real-world ego-machine hardware component(s) 189 can handle at the angular resolution requirements. The virtual data mapping module 185 then pass such mapped/converted information to the real-world ego-machine hardware component(s) 189 (e.g., a processor of a cockpit ECU), which then processes the laser pulses and time and outputs a point cloud. A point cloud is a collection of individual points in space, and each point represents a specific location in the sensor's field of view. In some embodiments, the real-world ego-machine hardware component(s) 189 then instructs the virtual cockpit simulator 192 (which then instructs the virtual display module 190) to display the point cloud (e.g., a LiDAR three-dimensional point cloud) at the virtual display device.

The virtual cockpit simulator 192 is generally responsible for generating and/or modifying a virtual cockpit or cabin area of a virtual ego-machine that represents a real-world ego-machine based at least partially on the data received from the real-world ego-machine hardware component(s) 189. For example, the view generator 180 may produce an adaptive 3D bowl 170, which includes a particular geographic environment (e.g., a portion of a road) and natural sunlight characteristic (e.g., representing noonday). Responsively, the virtual cockpit simulator 192 may generate a windshield at a virtual cockpit such that at least a portion of the geographic environment and lighting characteristic are represented and indicated as being visible through the windshield. In some embodiments, the virtual cockpit of the virtual ego-machine represents a same virtual ego machine that contains virtual sensors 101 responsible for producing the virtual sensor data 105.

In some embodiments, the virtual cockpit simulator 192 is a component of digital twin functionality, which generates a digital twin of a real-world cockpit of a real-world ego-machine. A digital twin of a cockpit may refers to a digital representation or replica of a physical real-world cockpit. For example, in architectural design, a digital twin of a cockpit might be created in NVIDIA's OMNIVERSE to simulate how the cockpit (or components of the cockpit, such as a virtual display device) would behave under different conditions, such as varying weather, lighting, or occupancy. This can help architects and engineers test and refine their designs before they are built in the real world.

To build such digital twins, in some embodiments, data is collected from various sensors (e.g., the sensor(s) 101, such as a virtual Driver Monitoring System camera (DMS) to capture video data of a cockpit). These sensors can capture information about physical properties, such as temperature, humidity, light, sound, and more. 3D scanners, LiDAR (Light Detection and Ranging), and photogrammetry, or other sensors may be used to capture detailed geometric information. This data is used to create a 3D model of the object or environment. Once the sensor data is collected, it may be processed and transformed into a format that can be used to create a digital twin. This may involve data cleaning, calibration, and normalization. Geometric data acquired from scanning and imaging can be used to create a 3D model of the cockpit. This model can include the shape, size, and structure of the real-world cockpit. Simulation data, such as environmental conditions and sensor readings, can be integrated into the digital twin to make it more realistic and functional.

To indicate reflections and other visual characteristics at the virtual cockpit, material properties and textures may be assigned to the 3D model. This includes specifying how light interacts with different surfaces. For instance, embodiments may define materials to be reflective, transparent, or translucent. In some embodiments, digital twins are designed to provide real-time updates. This means that as the real-world object or environment changes, the digital twin reflects those changes. For instance, if lighting conditions change, the digital twin should adjust its visual representation accordingly. In some embodiments, digital twins are integrated with simulation functionality that may accurately replicate the behavior and performance of the real-world counterpart. This allows users to interact with and analyze the digital twin in different scenarios. Users can interact with the digital twin of the cockpit (or its components, such as a virtual display device) through user interfaces and applications. They can explore the twin, run simulations, and analyze its behavior.

The virtual display module 190 of the virtual cockpit simulator 192 is generally responsible for displaying at least a portion of the output produced by the real-world-ego machine hardware component(s) 189 to one or more virtual display devices in the virtual cockpit generated by the virtual cockpit simulator 192. For example, the real-world ego-machine hardware component(s) 189, such as a cockpit ECU, may generate real-world and near real-time video data with detected objects and the virtual display module 190 may return such data to a virtual display screen within a virtual display device. In this way, for example, the cabin or cockpit area within a virtual ego-machine may be a digital twin or virtual representation of a real-world ego machine cockpit area. However, the virtual display screen within a virtual display device may output real-world data from the view generator 180, such as a video, which could be displayed to a real-world ego-machine's real-world display device.

The user input handler 187 is generally responsible for handling user input to and/or from one or more virtual display devices controlled by the virtual display module 190. For example, the user input handler 187 may receive an indication that a user has clicked at a particular coordinate location on a virtual display device, made a video game gesture, or otherwise has provided user input. In some embodiments, the virtual data mapping module 185 maps or translates the user input into sensor data inputs. For example, an indication of a user click at a portion of a virtual display device (generated by the virtual display module 190) may first be received. The virtual data mapping module 185 maps such user input as if this user input is coming from a real touch system. For example, some embodiments map the coordinates (e.g., X and Y axis point) that the user input was made at, at the virtual display device to the real-world ego-machine hardware component's coordinates. Particular embodiments then inject such coordinates into a test port. Between a real-world display device and a command control unit (e.g., the real-world ego-machine hardware component 189), there may be a test port where a command can be injected. In this way, the real-world ego-machine hardware component 189 processes the user input as an actual touch input, for example, at the matching location.

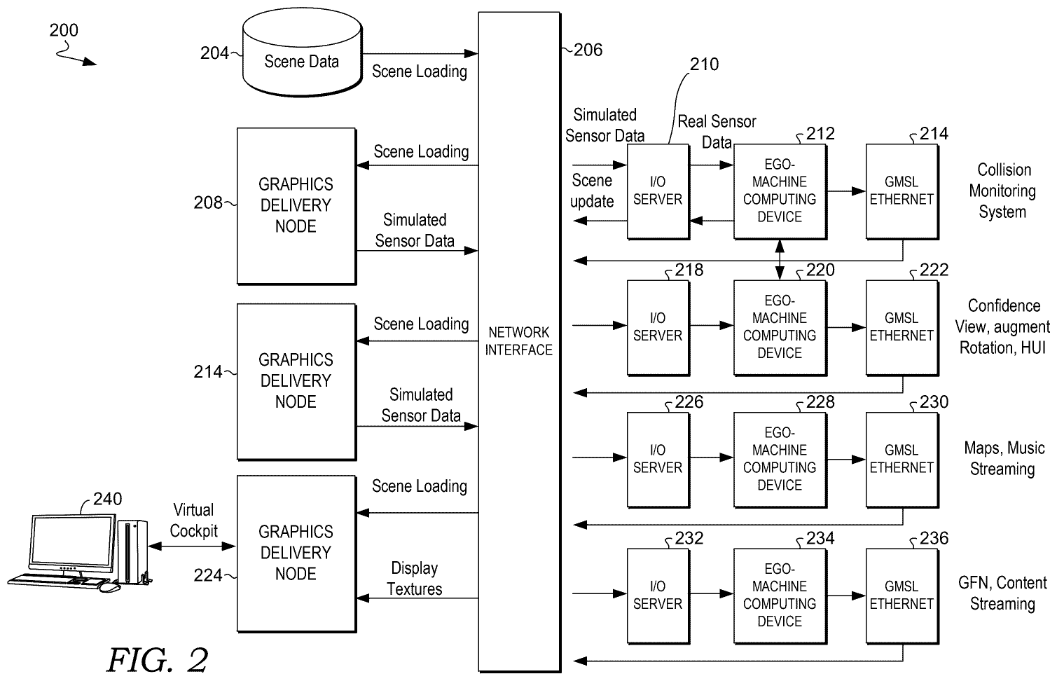

Referring now to FIG. 2, a hardware system architecture 200 (referred to as “system 200”) for generating a virtual cockpit and data within one or more virtual display devices within the virtual cockpit, according to some embodiments. In some embodiments, the system 200 includes one or more of the components of the system 100, as described in more detail below. In some embodiments, except for the user device 240, the system 200 describes components located in a datacenter.

At a first time, one or more scenes-referred to as scene data 204—are loaded to storage (e.g., cache or RAM). In some embodiments, the scene data 204 may include the output produced by the sensor(s) 101, and/or the view generator 180. Alternatively or additionally, in some embodiments, the scene data 204 represents the simulated environment 810 provided by the neural networks (e.g., DNNs) or other methods described with respect to FIG. 8A through 8C. Additionally or alternatively, in some embodiments, the scene data 204 may represent what is generated by one or more scene authoring techniques, as described herein. For example, a database and collaboration engine of can be accessed, where teams can have multiple users connected together live across several applications all at once. Scene authoring allows an artist (or a team of artists) and/or a machine learning model to create scenes and corresponding USD files. In an illustrative example, scene authoring can include generating a virtual representation of an intersection, natural lighting visual data (representative of a sun at a particular time), and/or other virtual representations, such as pedestrians, roads, traffic signs, and traffic lights. In another example, scene authoring may produce simulated sensor data via, such as a map or simulated image of one or more scenes, as derived from a virtual radar, virtual GPS, virtual LiDAR and/or virtual camera.

Some embodiments then load, over the network interface 206, scene data 204 to the graphical content delivery nodes 208, 216, and/or 224 (e.g., respective NVIDIA OVX nodes). The graphics delivery nodes 208 and 216 are responsible for delivering, to the I/O servers 210 and 218 respectively, graphics or simulations representative of the scene data 204. For example, the graphics delivery nodes 208 and 216 may convert, in near real-time, the scene data 204 into a digital twin of the real-world video feed of an environment derived from the sensor(s) 101. In some embodiments, the network interface 206 represents any suitable interface, such as a network adapter or network interface card (NIC) that connects the graphics delivery nodes (e.g., 208) to the other ego-machine computing devices (e.g., 212), and/or other devices to a data center network.

The graphics delivery node 224 (e.g., another OVX node) is generally responsible for generating a virtual cockpit of a virtual ego-machine—as well as one or more virtual display devices within the virtual cockpit-based on taking, as input, the graphics delivered by the graphics delivery nodes 208 (and/or 216) to load a scene as well as display textures or other elements derived from the respective ego-machine computing devices 212, 220, 228, and 234. For example, the graphics delivery node 224 may generate a digital twin of a cockpit (e.g., based on sensor(s) 101) and place a particular natural lighting texture outside of a virtual windshield of a virtual ego-machine cockpit (representative of the outside driving environment) based on the natural lighting characteristic being present at the scene as generated from the graphics delivery node 208. In another example, the graphics delivery node 224 may cause display, at a virtual display device within the virtual cockpit, video steaming service videos based on receiving such information from the ego-machine computing device 234.

The ego-machine computing device's 212 and 220 are generally responsible for determining and providing autonomous vehicle (AV) related information. For example, a surround view system (SVS), also known as a 360-degree camera system or bird's-eye view system, is an advanced automotive technology that provides a driver with a comprehensive view of the area surrounding their vehicle. It typically uses multiple cameras strategically placed around the vehicle to capture images from all sides, which are then processed and stitched together to create a composite, bird's-eye view of the vehicle and its immediate surroundings. As described herein, (e.g., with respect to the view generator 180), a virtual SVS system along with virtual sensors may provide the adaptive 3D bowl 170 so as to, for example, capture a virtual environment (e.g., the scene data 204) around a virtual ego machine to capture images from all sides, which are then stitched together to form an adaptive 3D bowl.

The I/O server 210 receives such simulated data (e.g., the adaptive 3D bowl described above), and maps or translates it into real-world sensor data (e.g., via the virtual data mapping module 185), which is then fed to the ego-machine computing device 212. The ego-machine computing device 212 (and ego-machine computing device 220) is a computing device (e.g., that contains a GPU, CPU, and/or memory) that controls or powers other real-world ego-machine hardware components (e.g., a cockpit ECU) and/or controls or handles autonomous driving tasks (e.g., via NVIDIA's DRIVE AV stack). For example, the ego-machine computing device 212 may provide real-world video of a 3D bowl. In some embodiments, one or more of the computing devices 212, 220, 228, or 234 controls or include the real-world ego-machine hardware component(s) 189 of FIG. 1. In an example illustration of an ego-machine computing device 212, this may represent NVIDIA's DRIVE ORIN, which is typically a central computing device located in a vehicle, but it can instead be located in a datacenter. In some embodiments, each of the ego-machine computing devices 212, 220, 228, and 234 may represent a system-on-a-chip (SoC) that delivers high-performance computing for intelligent vehicles. It can power various applications and functions, such as autonomous driving, in-vehicle infotainment (IVI), digital clusters, and AI cockpits.

Ego-machine computing device 212 may then pass, over the Ethernet 214 and the network interface 206, a scene update (e.g., a 3D bowl or real-world video feeds) to the graphics delivery node 224 (e.g., which includes the virtual cockpit simulator 192), which causes display, at the user device 240, the scene update, and/or display textures for display at the virtual ego-machine's virtual display screen at the virtual cockpit, which would typically help, for example, a driver navigate and park with greater ease and safety. In this way, the virtual display device at a virtual cockpit can contain real-world video data (e.g., a video of the scenery surrounding a vehicle moving in real-time), which is distinguished from the rest of the virtual cockpit, which is not real-world data, but is rather a simulated (e.g., 3D twin) virtual cockpit of a real-world counterpart.

Alternatively or additionally, the graphics delivery node 208 provides simulated sensor data related to a Collision Mitigation system (CMS). A CMS A Collision Management System (CMS) is a technology or system designed to monitor, detect, and potentially mitigate or prevent collisions in various settings, including vehicles, industrial equipment, and other contexts. One goal is to enhance safety by reducing the risk of collisions. In the context of vehicles, a Collision Management System may refers to an advanced driver assistance system (ADAS) that includes various features, such as collision detection, collision warning, and collision avoidance. Virtual representations of CMS may use one or more virtual sensors, such as virtual radar, virtual LiDAR, virtual cameras, and virtual ultrasonic sensors to continuously monitor, in near-real time, the virtual vehicle's surroundings. It can detect (e.g., via object detection or segmentation) other virtual vehicles, virtual pedestrians, and obstacles in the virtual vehicle's path. CMS can also detect an imminent collision or a dangerous situation. In an illustrative example, the simulated sensor data from virtual radar, LiDAR, camera, and virtual object detection can be passed to the I/O server 210, which maps the simulated sensor data to real-world sensor data for input into the ego-machine computing device 212. Based on processing the real-world sensor data, the ego-machine computing device 212 then passes the scene update (e.g., visual or audible warnings, such as a bounding box) over the Ethernet 214, over the network interface 206, to the graphics delivery node 224, which causes display, at the user device 240 and within the virtual display device within the virtual cockpit of the virtual ego-machine, an alert (e.g., “pedestrian 5 feet away”) to alert drivers of the potential danger. Such data presented at the virtual display device may include forward collision warnings, lane departure warnings, or blind-spot warnings.

An identical or similar process can occur for the graphics delivery node 216, the I/O servers 218, 226, and 232, the ego-machine computing devices 220, 228, and 236, and/or the Ethernet devices 222, 230, and 236. The ego-machine computing devices 220, 228, and 234 are responsible for controlling: visualization (e.g., via a user interface, AR, VR, or MR overlays) of one or more real-world devices (e.g., a real-world display device), driver monitoring of a real-world ego-machine (e.g., via NVIDIA's DRIVE IX stack), audio, and/or service or application related data.

In some embodiments, the ego-machine computing device 220 is responsible for providing one or more of a Human-computer interface (HUI), Augmented Reality (AR), or confidence view (e.g., perception confidence). For example, the ego-machine computing device 220 may instruct the graphics delivery node 224 to cause display, at a virtual display device, augmented reality displays in the virtual ego-machine that overlay information about the confidence levels of the vehicle's perception system onto the real-world view (as produced from the ego-machine computing device 212). For example, the AR system might highlight virtual objects detected by the vehicle's virtual sensors and provide visual cues to indicate how confident the system is in its identification and location of those virtual objects. This information can help users understand the system's perception quality.

In some embodiments, the ego-machine computing device 228 is responsible for providing maps and music audio data from one or more music services. For example, the ego-machine computing device 228 may instruct the graphics delivery node 224 to display, at a virtual display device, ANDROID or GOOGLE maps (e.g., satellite imagery, street view, and route planning for traveling by foot, car, bicycle, or public transportation). The ego-machine computing device 228 (e.g., a real-world audio amplifier and/or an ECU) may additionally or alternatively instruct the graphics delivery node 224 to emit, at a virtual speaker or virtual radio inside of a virtual ego-machine, streaming service music so that users can test sound quality.

In some embodiments, the ego-machine computing device 234 is responsible for providing or streaming video data from one or more media content services, gaming data, and/or weather data. For example, the ego-machine computing device 234 (e.g., via a real-world ECU) may instruct the graphics delivery node 224 to display, at a virtual display device, video streaming service (e.g., NETFLIX) user interface data or video and/or gaming data, such as GeForce NOW cloud gaming service data. The ego-machine computing device 228 (e.g., an In-vehicle Infotainment (IVI) device) may further instruct the graphics delivery node 224 to display, at a virtual display device, the streaming service video (actual real-world video, such as a sequence of frames, where each frame is a still image captured at a specific moment in time), video game scenes, or the like.

In some embodiments, each ego-machine computing device 212, 220, 228, and 234 is responsible for controlling functions related to any suitable quantity of virtual display devices within a virtual ego-machine (and are capable of controlling their real-world device (e.g., infotainment device) counterparts). For example, the ego-machine computing device 212 may be responsible for providing its data to a virtual ego-machine's virtual center-console infotainment device. The ego-machine computing device 220 may be responsible for providing its own data to two other virtual display devices that are represented as being connected to the back of virtual seats within the same virtual ego-machine.

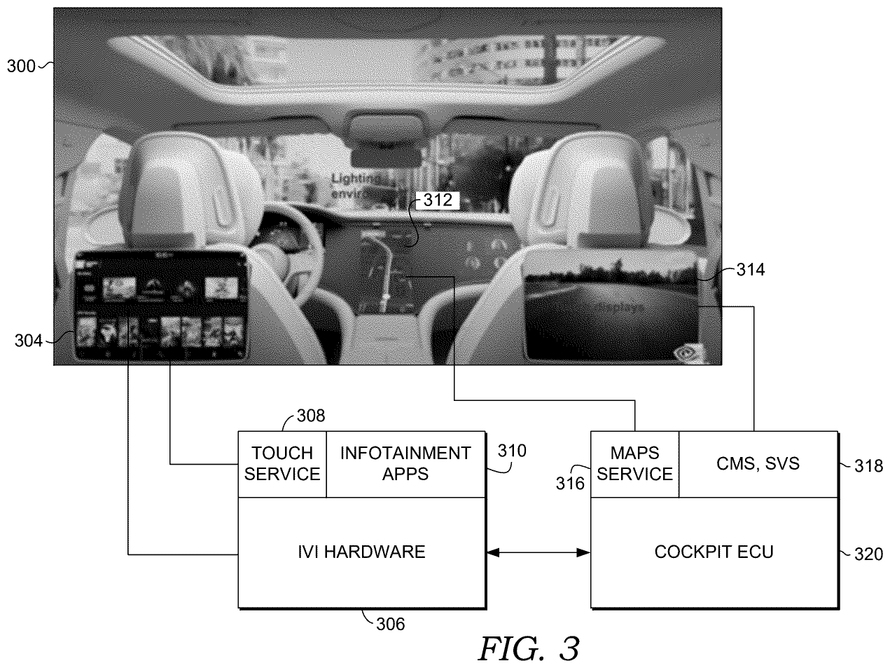

FIG. 3 is a schematic diagram illustrating how a virtual cockpit 300 of a virtual ego-machine may appear, according to some embodiments. The virtual cockpit 300 includes a virtual center console display device 312, and two virtual headrest displays 304 and 314 (each of which may be referred to as a “virtual display device”). In some embodiments, the virtual cockpit 300 is generated by the virtual cockpit simulator 192 of FIG. 1, or the graphics delivery node 224 of FIG. 2. The virtual cockpit 300 may be what is displayed at the user device 240 of FIG. 2.

Each of the virtual display devices 312, 304, and 314 displays real-world data based on instructions provided from one or more real-world ego-machine hardware components, which are represented by the IVI hardware 306 and cockpit ECU 320 in FIG. 3. In some embodiments, the IVI hardware 306 and/or the cockpit ECU 320 represent the real-world ego-machine hardware component(s) 189 of FIG. 1. Alternatively or additionally, in some embodiments, the IVI hardware 306 and/or the cockpit ECU 320 represent, are powered/controlled by, and/or are included in one or more of the ego-machine computing devices 212, 220, 228, or 234 of FIG. 2. For example, in some embodiments, the IVI hardware 306 represents a hardware component that the ego-machine computing device 234 controls to present a user interface of video streaming icons representing different movies, as illustrated within a virtual display area of the virtual display device 304 of FIG. 3. In another example, the cockpit ECU 320 may represent a hardware component that the ego-machine computing device 212 controls to present real-time video data of a geographical area representing what is in front of a virtual car, as illustrated within a virtual display area of the virtual display device 314.

In some embodiments, the IVI hardware 306 and the cockpit ECU 320 work together by communicating through a common platform and a high-speed network, such as Ethernet or CAN (Controller Area Network). The cockpit ECU 320, for example, may act as a hub that processes the data and commands from the IVI hardware 306 and other sources, and projects the output on each of the virtual display devices 304, 312, and 314. The IVI hardware 306 may also receive feedback and input from the cockpit ECU 320 and other sensors, such as voice commands, touch screen, and gesture recognition. This way, the IVI hardware 306 and the cockpit ECU create a seamless and immersive experience via communication with each other.

As illustrated in FIG. 3, the IVI hardware 306 receives input from the touch service 308 and/or the infotainment apps 310 (e.g., which includes the media/video streaming user interface currently illustrated in the display area of the virtual display device 304 and/or backend media/video streaming functionality). A touch service is a feature or component (e.g., a server) that allows users to control a device by touching a display screen. For example, in response to receiving an indication of a mouse pointer (or voice-activated) selection of one of the icons representing a video streaming service movie at the virtual display device 304, the virtual data mapping module 185 first maps the simulated input into a real-world input (e.g., a touch input). Such real-world input is taken by the touch service 308 as input and responsively communicates, the real-world input to the infotainment apps 310 (e.g., a movie content streaming service), which instructs the IVI hardware 306 to responsively transmit, over a computer network and via an API, a request for media content related to the movie that corresponds to the selection. The infotainment apps 310 responsively returns the media content to the IVI hardware 306, which then causes display, at the virtual display device 304 and via the formatting requirements of the infotainment apps 310, of the movie content.

As illustrated in FIG. 3, the cockpit ECU 320 transmits requests to and receives input from the maps service 316 and/or the CMS, SVS application 318. For example, in response to receiving an indication of a mouse pointer (or voice-activated) selection of a maps service icon at the virtual display device 312, the virtual data mapping module 185 first maps the simulated input into a real-world input (e.g., a touch input). Such real-world input is taken by cockpit ECU 320 as input, and responsively transmits, over a computer network and via an API, a request to the maps service 316 for map data (e.g., directions) that corresponds to the selection. The maps service 316 responsively returns the maps data to the cockpit ECU 320, which then causes display, at the virtual display device 312 of the maps data. In another example, in response to receiving an indication of a selection of a CMS or SVS feature at the virtual display device 314, the virtual data mapping module 185 first maps the simulated input (e.g., including virtual LiDAR sensor data) into a real-world input (e.g., actual LiDAR sensor data). Such real-world input is taken by cockpit ECU 320 as input, and responsively causes display, at the virtual display device 314 and via the CMS, SVS application 318, of CMS and/or SVS data, such as a real-world adaptive 3D bowl and corresponding AR, VR, and/or MR overlays (e.g., bounding boxes) and/or other information, such as collision warnings.

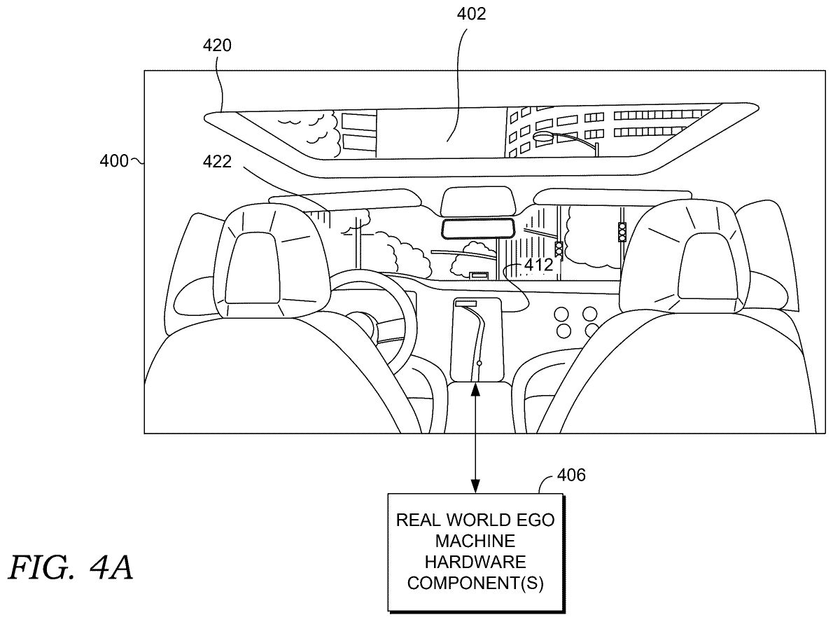

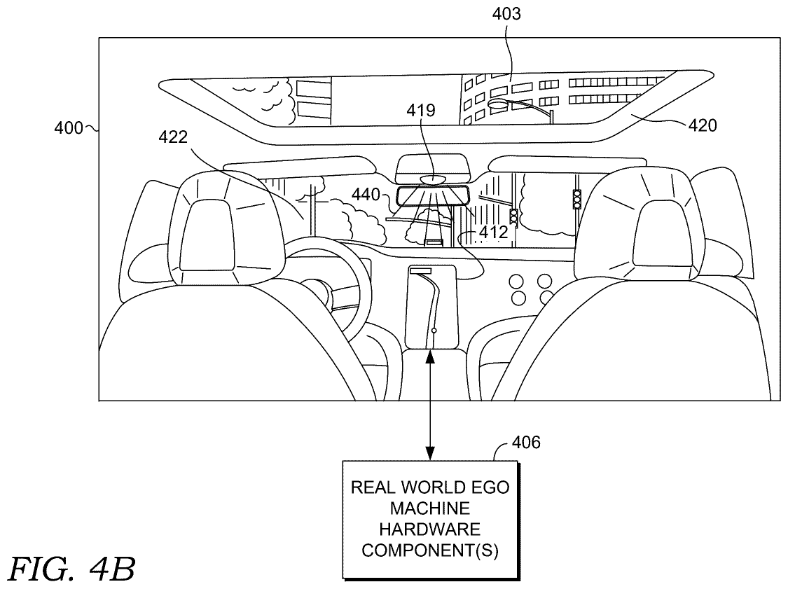

FIG. 4A is a schematic diagram illustrating how a virtual cockpit 400 of a virtual ego-machine and respective virtual display devices may appear based on a natural lighting condition 402, according to some embodiments. The virtual cockpit 400 includes a virtual center console device 412 (which may be referred to as a “virtual display device”). In some embodiments, the virtual cockpit 400 is generated by the virtual cockpit simulator 192 of FIG. 1, or the graphics delivery node 224 of FIG. 2. The virtual cockpit 400 may be what is displayed at the user device 240 of FIG. 2.

FIG. 4A also illustrates one or more real-world ego machine hardware components 406. In some embodiments, the one or more real-world ego machine hardware components 406 represent, are included in, or include one or more real-world ego machine hardware components 189 of FIG. 1, one or more of the ego-machine hardware computing devices 212, 220, 228, and/or 234, the IVI hardware 306 of FIG. 3, and/or the cockpit ECU 320 of FIG. 3. The one or more real-world ego machine hardware components 406 are illustrated as powering or controlling operations of the virtual display device 412.

The natural lighting characteristic 402 represents natural lighting (e.g., noon-day sun), shading, reflectance and/or other data defining how materials react to light (e.g., via a Spatially-varying Bidirectional Reflectance Distribution Function (SVBRDF)). In some embodiments, the natural lighting characteristic 402 additionally or alternatively represents ray tracing functionality. Ray tracing is a technique used to simulate the way light interacts with objects in a virtual environment. It may be used to create realistic lighting, reflections, and shadows in rendered images or videos.

In some embodiments, the natural lighting characteristic 402 and/or the geographical environment outside of the virtual ego-machine (which is viewable outside of the virtual windshield 422 and virtual sunroof 420 of the virtual cockpit 400) represents a digital twin or graphics produced by the graphics delivery node 208 of FIG. 2 or the view generator 160.

In some embodiments, the natural lighting characteristic 402, such as simulated sun rays, emanate or penetrate (e.g., via ray tracing) into the virtual cockpit 400, which may change or determine how various interior portions within the virtual cockpit 400 appear, including the virtual display device 412 and/or the data that is presented thereon. For example, in some embodiments, the brightness (e.g., via automated brightness level functionality), resolution, and/or screen reflectivity of data displayed to the virtual display device 412 may change or be generated based on the quantity of the natural lighting characteristic 402 or other lighting properties present in the virtual cockpit 400. Accordingly, for example, in response to the real-world ego-machine hardware component(s) 406 detecting that the natural lighting characteristic 402 has met or exceeded some threshold (e.g., a brightness level), the real-world ego machine hardware component(s) cause display of data within the virtual display device 412 at a particular brightness, resolution, screen reflectivity, etc.

FIG. 4B is a schematic diagram illustrating how an appearance of the virtual cockpit 400 of FIG. 4A changes based on a change to the natural lighting condition 402 of FIG. 4A and/or an introduced lighting condition based on a virtual light 419, according to some embodiments. The natural lighting characteristic 403 represents natural lighting (e.g., no sunlight and/or lighting representative of moonlight or night), shading, reflectance and/or other data defining how materials react to light (e.g., via a Spatially-varying Bidirectional Reflectance Distribution Function (SVBRDF)).

In some embodiments, the natural lighting characteristic 403 additionally or alternatively represents ray tracing functionality, which may indicate that change from the natural lighting characteristic 402 in FIG. 4A (e.g., noonday) to the natural lighting characteristic 403 (e.g., midnight). Ray tracing works by tracing the path of light rays from the camera (or the eye) to the light sources in the scene, and calculating how they interact with different objects along the way. This allows for realistic effects such as shadows, reflections, refractions, and global illumination. In an illustrative example, with respect to FIG. 4A and FIG. 4B, ray tracing can be used to simulate sun up to sun down or any other change in lighting by adjusting the position, direction, color, and intensity of the light sources. For example, to create a sunset effect, the light source could be moved from above the horizon to below it, while changing its color white (indicating brightness), to yellow, to red (representing sunset), and decrease its brightness. This would affect how the light rays hit the objects in the scene, and create different shades and contrasts.

In some embodiments, the natural lighting characteristic 403, such as an absence of simulated light, emanate or penetrate (e.g., via ray tracing) into the virtual cockpit 400, which may change or determine how various interior portions within the virtual cockpit 400 appear (e.g., the seats and other portions of the interior may be less visible or darker based on less light), including the virtual display device 412 and/or the data that is presented thereon. For example, in some embodiments, the brightness (e.g., via automated brightness level functionality), resolution, screen reflectivity, of data displayed to the virtual display device 412 may change from FIG. 4A based on the quantity of the natural lighting characteristic 403 or other lighting properties present in the virtual cockpit 400. Accordingly, for example, in response to the real-world ego-machine hardware component(s) 406 detecting that the natural lighting characteristic 403 has met or fallen below some threshold (e.g., a brightness level), the real-world ego machine hardware component(s) 406 cause display of data within the virtual display device 412 at a particular brightness, resolution, screen reflectivity, etc.). For example, the brightness level may adjust to a lower setting relative to the brightness level in FIG. 4A based on the simulated data indicating nighttime lighting characteristics instead of noon bright ambient environment characteristics.

In some embodiments, the virtual light 419 produces a separate lighting characteristic 440 (e.g., simulating a localized set of light photons) that emanates or penetrate (e.g., via ray tracing) into the virtual cockpit 400. This may additionally or alternatively change or determine how various interior portions within the virtual cockpit 400 appear (e.g., 1 seat and other portions of the interior may be more visible than other portions that are not immediately surrounding the virtual light 419). Such lighting characteristic 440 may also have an effect of the display area of the virtual display device 412 and/or the data that is presented thereon. For example, in some embodiments, the brightness (e.g., via automated brightness level functionality), resolution, and/or screen reflectivity, of data displayed to the virtual display device 412 may change from FIG. 4A based on the quantity of the lighting characteristic 440 or other lighting properties present in the virtual cockpit 400. Accordingly, for example, in response to the real-world ego-machine hardware component(s) 406 detecting that the lighting characteristic 4440 has met or is above some threshold (e.g., a brightness level), the real-world ego machine hardware component(s) 406 cause display of data within the virtual display device 412 at a particular brightness, resolution, screen reflectivity, etc.

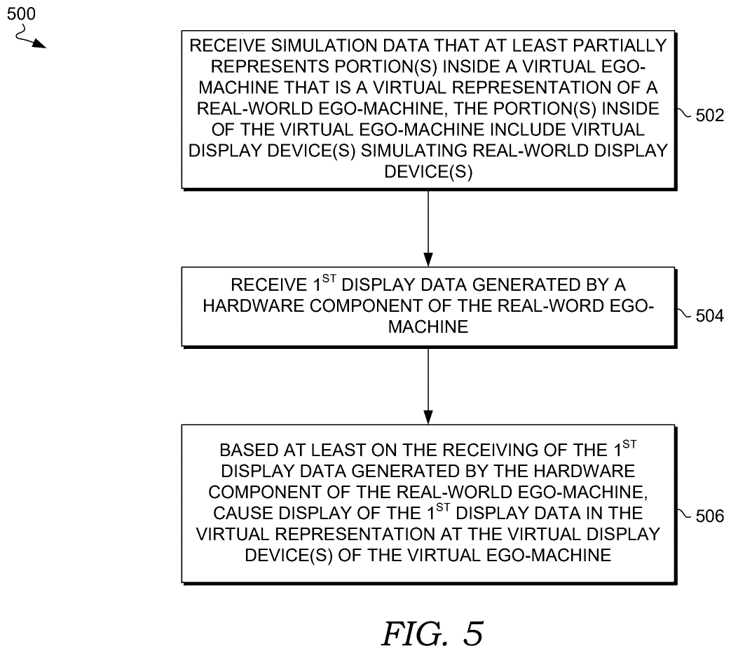

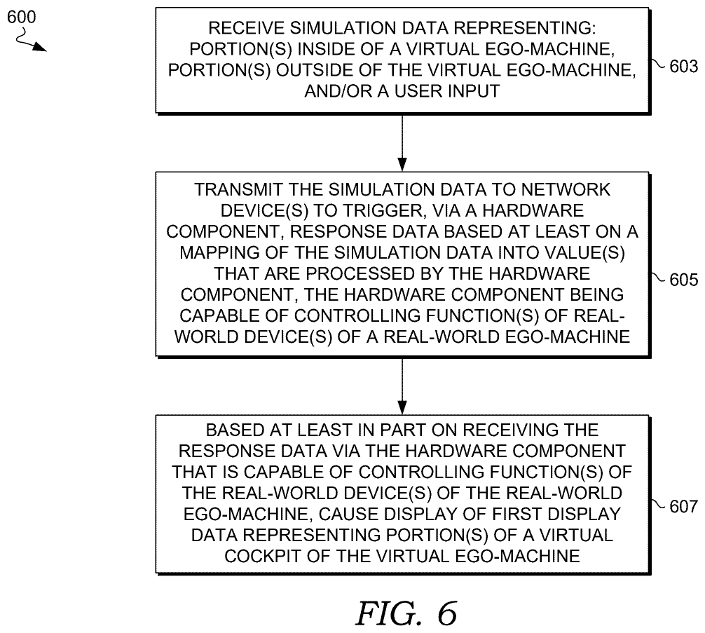

Now referring to FIGS. 5 and 6, each block of processes 500 and 600 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 500 and 600 are described, by way of example, with respect to the system 100 of FIG. 1. However, these processes may additionally or alternatively be executed by any one system, or any combination of systems, including, but not limited to, those described herein.

FIG. 5 is a flow diagram of an example process 500 for causing display of display data in one or more virtual display devices of a virtual ego-machine, according to some embodiments. Per block 502, some embodiments may receive simulation data that at least partially represents one or more portions of an interior of a virtual ego-machine that is a virtual representation of a real-world ego-machine, where the one or more portions of the interior of the virtual ego-machine include one or more virtual display devices simulating one or more real-world display devices. The one or more portions may, for example, be a cockpit, a backseat, a driver-side area, a windshield, and/or passenger side area within a virtual ego-machine. In an illustrative example, the simulation data may include the virtual cockpit 300 of FIG. 3. A “virtual representation” of something is a digital model (e.g., a digital twin) or data object that simulates or mimics the characteristics, behavior, and/or appearance of its real-world counterpart. For example, a virtual representation of a car can simulate how it looks, how it performs, and how it reacts to different conditions (e.g., lighting conditions). In an illustrative example, a virtual representation of an ACURA TL (e.g., a real-world ego-machine) may be its digital twin that mimics or simulates its interior color, its interior type (e.g., leather), its seat quantity, its seat type (e.g., bucket seats), its quantity of display devices, steering wheel, infotainment device options and features (e.g., surround cameras for parking), or the like. The term “virtual” as described herein is not limited to virtual reality (VR), but can included any digital representation, such as a digital twin, Mixed Reality (MR), and/or Augmented Reality (AR).

In some embodiments, the simulation data includes a representation of a natural lighting characteristic outside of the virtual ego-machine. For example, such representation can include the natural lighting characteristic 402 or 403 of FIG. 4A or FIG. 4B. In some embodiments, the simulation data additionally or alternatively includes a representation of a lighting characteristic according to a placement of a virtual source of illumination (e.g., the virtual light 419 of FIG. 4B) within the interior of the virtual ego-machine. In some embodiments, the simulation data alternatively or additionally includes a representation of a scene configuration outside of the virtual ego machine. For example, such scene configuration can include the output of the view generator 180 or the adaptive 3D bowl 170 of FIG. 1 or the virtual environment visible outside of the virtual windshield 422 of FIG. 4A. In some embodiments, the simulation data additionally or alternatively represents any user input, such as the user input handled by the user input handler 187 of FIG. 1.

In some embodiments, the simulation data at block 502 is accessible via one or more augmented or virtual reality devices (e.g., a virtual reality headset) associated with one or more teams of designers or developers. For example, the virtual cockpit 300 or other simulated data may be part of a consumer application that is powered by a graphics delivery service that allows real-time collaboration between designers or developers. The simulation data my thus correspond to a service where designers or engineers could view and control the simulation for a car (e.g., the lighting conditions in a virtual cockpit 400 from FIG. 4A to FIG. 4B) they are designing, running from a data center. This means that both the machine where the simulation runs and the IVI hardware, for example, could be in a datacenter so that the engineer/designer need not have any physical device at their desk or otherwise with them for testing.

In some embodiments, the simulation data is alternatively or additionally representative of at least one of, a user interface design tool for the one or more real-world display devices of the real-world ego machine or an ego-machine design tool for designing one or more portions of an interior portion of the real-world ego-machine. For example, with respect to the ego-machine design tool, the virtual cockpit 400 in FIGS. 4A and 4B or other simulated data may be part of a consumer application that is powered by a graphics delivery service that allows an engineer to test how the interior of the virtual cockpit looks under different lighting simulations represented in FIG. 4A and FIG. 4A. For example, a digital twin of an interior material, such as a type of leather, may have some unexpected reflectance properties (e.g., as simulated via ray tracing functionality). Accordingly, the user may change the digital twin interior to different types if and until the reflectance properties look more aesthetically pleasing. Additionally or alternatively, other properties may be modified in real-time, such as different virtual steering wheel options of the virtual ego-machine, different virtual steering wheel positions, different virtual in-car light placements, virtual glass tint, etc. The experience may be enhanced by realistic rendering or lighting since several physical aspects can be more accurately portrayed with physically accurate lighting. Some embodiments, for example, may therefore may receive a request to change or modify one or more data objects within the virtual cockpit, such as chairs, virtual display devices, or the like and such objects can be responsively replaced.

With respect to the user interface design tool, for example, an engineer working on the UI (e.g., main launcher, different apps) may not be able to see how it will look in the real-world car environment. Some things to consider are how some apps will look from different seats in the car with a specific screen size, the text size, how well colors in the UI suit lighting in the car. However, a user can see these things in a digital twin environment, for example.

Per block 504, some embodiments receive first display data generated by a hardware component of the real-world ego-machine. For example, as described with respect to FIG. 1, the display data of the real-world ego-machine hardware component(s) 189 may be real-world CMS, SVS, AR data, map data, music service data, streaming service data, and/or the like as described with respect to FIG. 2. The “hardware component” may additionally or alternatively be or include the ego-machine computing device(s) 212, 220, 228, and/or 234 of FIG. 2, the IVI hardware 306, the cockpit ECU 320, and/or the real-world ego-machine hardware component(s) 406 of FIG. 4A and FIG. 4B.

Some embodiments may predict, based on the representation of a scene configuration, virtual sensor data representative of one or more portions outside of the virtual machine. Examples of this are described with respect to the output of the view generator 180. This may trigger the hardware component (e.g., by graphics delivery node 208, sending, over the network 206, simulated sensor data to the I/O server 210 to provide to the ego-machine computing device 212) to generate real-world video data based at least in part on processing the virtual sensor data. Examples of the data include the CMS and/or SVS data as described with respect to FIG. 2.

Some embodiments receive user input made at the one or more virtual display device that simulate the one or more real-world display devices. And in response to the receiving of the user input, some embodiments trigger the hardware component to generate or cause the display, at the one or more virtual display device of the first display data based at least on the receiving of the user input and interpreting the user input as a touch input. Examples of this are described in FIG. 3 with respect to the touch service 308, the infotainment apps 310 and the IVI hardware 306 working together so that the IVI hardware 306 can generate the visual data as illustrated at the virtual display device 304.

Per block 506, based at least on the receiving of the first display data generated by the hardware component of the real-world ego-machine, some embodiments cause display of the first display data in the virtual representation at the virtual display device(s) of the virtual ego-machine. Examples of this are described with respect to the displayed data at the virtual display device 304, the virtual display device 314, and/or the virtual display device 312 of FIG. 3. For example, where the simulation data includes a representation of a natural lighting characteristic outside of the virtual ego-machine, the display of the first display data may be based at least in part on the representation of the natural lighting characteristic. Examples of this are described, for example, in FIG. 4A where the display (e.g., the brightness level) of the data at virtual display device 412 may be based on the natural lighting characteristic 402.

In another example, where the simulation data includes a representation of a lighting characteristic according to a placement of a virtual light inside the virtual ego-machine, the display of the first display data may be based at least on the representation of the lighting characteristic according to the placement of the virtual light. Examples of this are described with respect to FIG. 4B where, for example, the display (e.g., brightness) of the data displayed to the virtual display device 412 may be based at least on virtual light photons emanating from the virtual light 419 of FIG. 4B.

In some instances, where the simulation data includes a representation of a scene configuration, some embodiments trigger the hardware component to generate real-world video data based at least on processing virtual sensor data, where the display, at the virtual display device(s) of the first display data includes the real-world video data based at least on the prediction of the virtual sensor data. Examples of the real-world video data are illustrated with respect to the video data displayed at the virtual display device 314 of FIG. 3.

In some instances, where the simulation data includes user input, some embodiments trigger the hardware component to cause the display, at the one or more virtual display devices, of the first display data based at least on the receiving of the user input and interpreting the user input as a touch input. Examples of this are described with respect to the display data at the virtual display device 304 of FIG. 3, which user input, the touch service, and infotainment apps 310 as input.

In some instances, the user input and the display outputs involve a video game controller and video game functionality. In response to the receiving of the user input, some embodiments trigger the hardware component to cause the display, at the one or more virtual display device, of a video game feed (e.g., a real-time video game sequence of a fight) that includes the first display data. In some embodiments, there is an “enter” or “exit” mode functionality so that the user can enter or exit a game context based on different functionality that an ego-machine and corresponding display device functionality that can be performed. For example, a cockpit ECU may be responsible for using cameras (or virtual cameras) to detect objects, as well as cause display of a video game. A VR controller, for example, can be a game pad that can be used to play a game or the game pad can be used in OMNIVERSE to point and click on user interface elements to interact with VR simulation. In some embodiments, in order to switch modes, the user may be required to enter a key combination (e.g., right joystick plus X) on the game pad to enter a particular mode.

Some embodiments modify or control, at the one or more virtual display devices, at least one of, a size, a location (e.g., X, Y coordinates at a screen), a resolution, screen reflectivity (a measure of how much light is reflected by a screen when there is a light source shining on it), or a brightness level of the first display data in the virtual representation of the real-world ego-machine based on at least one of, a display capability of the hardware component, a representation of a natural lighting characteristic outside of the virtual ego-machine, a user input at the one or more virtual display devices, or a representation of a lighting characteristic according to a placement of a virtual source of illumination within the interior of the virtual ego-machine. For example, in response to sensing the particular lighting characteristic 402 of FIG. 4A, particular embodiments automatically change the screen reflectivity of the virtual display device 412 or the SVBRDF of the surface of the seats (e.g., to glossy based on the lighting and finish of leather).

A “display capability” is the ability of the hardware component to cause display of various types of information, entertainment content, or handle various inputs. For example, a display capability may be the ability of a device to handle different touch gestures (e.g., pinching, tapping, dragging), a size of the display area of a display device, resolution that the first display data is displayed at, and responsiveness. In another example, in response to receiving a user request to change the color of the interior of a virtual cockpit, particular embodiments change the color, which takes into account the detected SVBRDF or ray tracing functionality.

In some embodiments, the hardware component includes an in-vehicle infotainment hardware (IVI) (e.g., 306 of FIG. 3) such that the one or more virtual display devices simulate a real-world infotainment device of the real-world ego-machine. Alternatively or additionally, in some embodiments, the hardware component includes a cockpit ECU (e.g. cockpit ECU 320 of FIG. 3).

In some embodiments, the process 500 is performed by one or more of the following: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

FIG. 6 is a flow diagram of an example process 600 for displaying one or more portions of a virtual cockpit, according to some embodiments. Per block 603, some embodiments receive simulation data representing one or more portions of an interior of a virtual ego-machine (e.g., the natural lighting characteristic 402 of FIG. 4A), one or more portions outside of the virtual ego-machine (e.g., data produced by the view generator 180 of FIG. 1), and/or a user input (e.g., user input received by the user input handler 187 of FIG. 1).

Per block 605, some embodiments (e.g., the graphics delivery node 208) transmit the simulation data to one or more network devices (e.g., the I/O server 210 and/or the ego-machine computing device 212) to trigger, via a hardware component (e.g., the IVI hardware 306 of FIG. 3), response data (e.g., the “updated scene” data in FIG. 2) based at least on a mapping (e.g., by the I/O server 21) of the simulation data (e.g., the “simulated sensor data” of FIG. 2) into one or more values (e.g., the “sensor data” of FIG. 2) that are processed by the hardware component. The hardware component is capable of controlling one or more functions of one or more real-world devices (e.g., infotainment devices) of a real-world ego-machine. For example, the hardware component may be a cockpit ECU placed in a data center. But if the cockpit ECU were to be placed within the interior of the real-world ego-machine, it can be configured to control SVS and/or other functions of real-world infotainment devices within the real-world ego-machine.

Per block 607, based at least in part on receiving the response data via the hardware component that is capable of controlling one or more functions of the one or more real-world devices of the real-world ego-machine, some embodiments cause display of first display data representing one or more portions of a virtual cockpit of the virtual ego-machine. For example, the first display data can be any data (e.g., a particular set of pixels) representing any object (e.g., steering wheel, chairs, interior color, windshield, center console, and/or virtual display devices) of the virtual cockpit 300 of FIG. 3, and/or the virtual cockpit 400 of FIG. 4A or FIG. 4B. In an illustrative example, the one or more portions within an interior of the virtual ego-machine at block 603 may include the natural lighting characteristic 402 of FIG. 4A. Responsive to detection of such natural lighting characteristic 402, some embodiments cause display of a particular color, SVBRDF, and/or ray tracing functionality of a seat/interior within the virtual cockpit. In another example, some embodiments cause one or more virtual display devices (e.g., the virtual display device 412) of the virtual ego-machine to present the first display data, such as generating a screen reflectivity value according to the detected natural lighting characteristic 402.

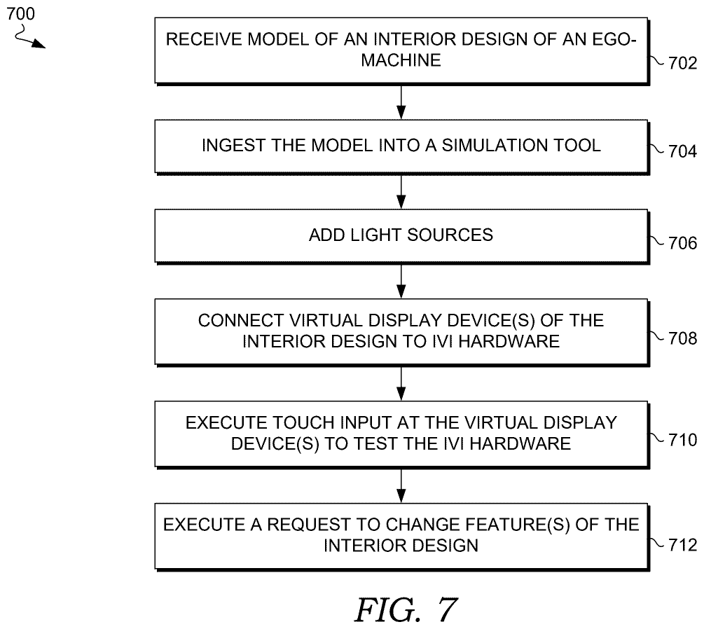

FIG. 7 is a flow diagram of an example process 700 for generating and modifying a mode of an interior design of an ego-machine, according to some embodiments. Per block 702, some embodiments receive a model (e.g., a Computer-aided Design (CAD)) of an interior design of an ego-machine (a real-world ego-machine). An “interior design” may include one or more portions of a virtual cockpit, such as the interior of the virtual cockpit 300 of FIG. 3.

Per block 704, some embodiments ingest the model into a simulation tool. For example, in response to user request, a CAD design of a virtual cockpit can be uploaded to a scene authoring or digital twin tool that is configured to generate additional simulation data (e.g., virtual lighting, virtual car traversal, etc.) over one or more time periods. For example, as described herein, a neural network can author a scene by changing the display of the interior of the virtual cockpit as the corresponding virtual ego-machine traverses through different areas and/or experiences different ambient lighting characteristics.

Per block 706, some embodiments add one or more light sources outside and/or within the interior design. In some embodiments, such adding occurs in response to a user request of the simulation tool. In an illustrative example of block 706, some embodiments add the natural lighting characteristic 402 of FIG. 4A/4B, the lighting characteristic 440 or the virtual light 419 of FIG. 4B to the CAD model.

Per block 708, some embodiments connect one or more virtual display devices of the interior design to IVI hardware (e.g., a hardware-in-loop (HIL) system). For example, some embodiments connect the IVI hardware over Ethernet to a touch service so that touch input requests from users can be processed for display at a virtual display device. In another example, some embodiments connect the IVI hardware to capture card for display of simulation. A capture card is a device that can record and stream gaming or streaming sessions. It works by capturing video and/or audio signal from a source, such as a console or a camera, and sending it to a computing device (e.g., a cockpit ECU) for processing.

Per block 710, some embodiments execute a touch input at the virtual display device(s) to test the IVI hardware. This is described, for example, with respect to FIG. 3 where, for example, the IVI hardware 306, touch service 308, and infotainment apps 310 are used to execute user touch requests to produce the display output at the virtual display device 304 as illustrated in FIG. 3.

Per block 712, some embodiments execute a request to change one or more features of the interior design. For example, particular embodiments receive a user request to adjust the lighting (e.g., the natural lighting characteristic 402 of FIG. 4A), placement of the lighting (e.g., changing position of the virtual light 440 of FIG. 4B), try different steering wheel options, try different car interior color or design types (e.g., leather versus microfiber), try different designs and/or locations of virtual display devices, try different seating/chair designs, and/or the like. Such user requests are then executed. In an illustrative example, some embodiments receive a request to change a position of the virtual light 440 in its current location above the center console as illustrated in FIG. 4B to a location more central or closer to a passenger bench behind the passenger and driver seat.

Now referring to FIG. 8A, FIG. 8A is an example illustration of a simulation system 800A, in accordance with some embodiments of the present disclosure. The simulation system 800A may generate a simulated environment 810 that may include AI objects 812 (e.g., AI objects 812A and 812B), HIL objects 814, SIL objects 816, PIL objects 818, and/or other object types. In some embodiments, the simulated environment 810 represents the output produced by the view generator 180 of FIG. 1 and/or the scene data 204 of FIG. 2. Alternatively or additionally, in some embodiments, the simulated environment represents the output produced by the virtual cockpit simulator 192 of FIG. 1, such as the virtual cockpit 300 of FIG. 3. The simulated environment 810 may include features of a driving environment, such as roads, bridges, tunnels, street signs, stop lights, crosswalks, buildings, trees and foliage, the sun, the moon, reflections, shadows, etc., in an effort to simulate a real-world environment accurately within the simulated environment 810. In some examples, the features of the driving environment within the simulated environment 810 may be more true-to-life by including chips, paint, graffiti, wear and tear, damage, etc. Although described with respect to a driving environment, this is not intended to be limiting, and the simulated environment may include an indoor environment (e.g., for a robot, a drone, etc.), an aerial environment (e.g., for a UAV, a drone, an airplane, etc.), an aquatic environment (e.g., for a boat, a ship, a submarine, etc.), and/or another environment type.

The simulated environment 810 may be generated using virtual data, real-world data, or a combination thereof. For example, the simulated environment may include real-world data augmented or changed using virtual data to generate combined data that may be used to simulate certain scenarios or situations with different and/or added elements (e.g., additional AI objects, environmental features, weather conditions, etc.). For example, pre-recorded video may be augmented or changed to include additional pedestrians, obstacles, and/or the like, such that the virtual objects (e.g., executing the software stack(s) as HIL objects and/or SIL objects) may be tested against variations in the real-world data.

The simulated environment may 810 be generated using rasterization, ray-tracing, using DNNs such as generative adversarial networks (GANs), another rendering technique, and/or a combination thereof. For example, in order to create more true-to-life, realistic lighting conditions (e.g., shadows, reflections, glare, global illumination, ambient occlusion, etc.), the simulation system 800A may use real-time ray-tracing. In one or more embodiments, one or more hardware accelerators may be used by the simulation system 800A to perform real-time ray-tracing. The ray-tracing may be used to simulate LIDAR sensor for accurate generation of LIDAR data. For example, ray casting may be used in an effort to simulate LIDAR reflectivity. In another example, virtual LIDAR data may be generated using a learned sensor model, as described in more detail above. In any example, ray-tracing techniques used by the simulation system 800A may include one or more techniques described in U.S. Provisional Patent Application No. 62/644,385, filed Mar. 17, 2018, U.S. Provisional Patent Application No. 62/644,386, filed Mar. 17, 2018, U.S. Provisional Patent Application No. 62/644,601, filed Mar. 19, 2018, and U.S. Provisional Application No. 62/644,806, filed Mar. 19, 2018, U.S. Non-Provisional patent application Ser. No. 16/354,983, filed on Mar. 15, 2019, and/or U.S. Non-Provisional patent application Ser. No. 16/355,214, filed on Mar. 15, 2019, each of which is hereby incorporated by reference in its entirety.

In some examples, the simulated environment 810 may be rendered, at least in part, using one or more DNNs, such as generative adversarial neural networks (GANs). For example, real-world data may be collected, such as real-world data captured by autonomous vehicles (e.g., camera(s), LIDAR sensor(s), RADAR sensor(s), etc.), robots, and/or other objects, as well as real-world data that may be captured by any sensors (e.g., images or video pulled from data stores, online resources such as search engines, etc.). The real-world data may then be segmented, classified, and/or categorized, such as by labeling differing portions of the real-world data based on class (e.g., for an image of a landscape, portions of the image—such as pixels or groups of pixels—may be labeled as car, sky, tree, road, building, water, waterfall, vehicle, bus, truck, sedan, etc.). A GAN (or other DNN or machine learning model) may then be trained using the segmented, classified, and/or categorized data to generate new versions of the different types of objects, landscapes, and/or other features as graphics within the simulated environment.

The simulator component(s) 802 of the simulation system 800 may communicate with vehicle simulator component(s) 806 over a wired and/or wireless connection. In some examples, the connection may be a wired connection using one or more sensor switches 808, where the sensor switches may provide low-voltage differential signaling (LVDS) output. For example, the sensor data (e.g., image data) may be transmitted over an HDMI to LVDS connection between the simulator component(s) 802 and the vehicle simulator component(s) 806. The simulator component(s) 802 may include any number of compute nodes (e.g., computers, servers, etc.) interconnected in order to ensure synchronization of the world state. In some examples, as described herein, the communication between each of the compute nodes (e.g., the vehicle simulator component(s) compute nodes and the simulator component(s) compute nodes) may be managed by a distributed shared memory (DSM) system (e.g., DSM 824 of FIG. 8C) using a distributed shared memory protocol (e.g., a coherence protocol). The DSM may include a combination of hardware (cache coherence circuits, network interfaces, etc.) and software. This shared memory architecture may separate memory into shared parts distributed among nodes and main memory, or distributing all memory between all nodes. In some examples, InfiniBand (IB) interfaces and associated communications standards may be used. For example, the communication between and among different nodes of the simulation system 800 (and/or 600) may use IB.

The simulator component(s) 802 may include one or more GPUs 805. The virtual vehicle being simulated may include any number of sensors (e.g., virtual or simulated sensors) that may correspond to one or more of the sensors described herein at least with respect to FIGS. 13A-13C and/or the virtual sensor(s) 105 of FIG. 1. Any or all of the sensors of the simulator component(s) 802 may be implemented using a corresponding learned sensor model, as described in more detail above. In some examples, each sensor of the vehicle may correspond to, or be hosted by, one of the GPUs 805. For example, processing for a LIDAR sensor may be executed on a first GPU 805, processing for a wide-view camera may be executed on a second GPU 805, processing for a RADAR sensor may be executed on a third GPU, and so on. As such, the processing of each sensor with respect to the simulated environment may be capable of executing in parallel with each other sensor using a plurality of GPUs 805 to enable real-time simulation. In other examples, two or more sensors may correspond to, or be hosted by, one of the GPUs 805. In such examples, the two or more sensors may be processed by separate threads on the GPU 805 and may be processed in parallel. In other examples, the processing for a single sensor may be distributed across more than one GPU. In addition to, or alternatively from, the GPU(s) 805, one or more TPUs, CPUs, and/or other processor types may be used for processing the sensor data.

Vehicle simulator component(s) 806 may include a compute node of the simulation system 800A that corresponds to a single vehicle represented in the simulated environment 810. Each other vehicle (e.g., 814, 818, 816, etc.) may include a respective node of the simulation system. As a result, the simulation system 800A may be scalable to any number of vehicles or objects as each vehicle or object may be hosted by, or managed by, its own node in the system 800A. In the illustration of FIG. 8A, the vehicle simulator component(s) 806 may correspond to a HIL vehicle (e.g., because the vehicle hardware 804 is used). However, this is not intended to be limiting and, as illustrated in FIGS. 8B and 8C, the simulation system 800 may include SIL vehicles, HIL vehicles, PIL vehicles, and/or AI vehicles. The simulator component(s) 802 (e.g., simulator host device) may include one or more compute nodes of the simulation system 800A, and may host the simulation of the environment with respect to each actor (e.g., with respect to each HIL, SIL, PIL, and AI actors), as well as hosting the rendering and management of the environment or world state (e.g., the road, signs, trees, foliage, sky, sun, lighting, etc.). In some examples, the simulator component(s) 802 may include a server(s) and associated components (e.g., CPU(s), GPU(s), computers, etc.) that may host a simulator (e.g., NVIDIA's DRIVE™ Constellation AV Simulator).

The vehicle hardware 804 (e.g., the real-world ego-machine hardware component(s) 189 of FIG. 1) may be incorporated into the vehicle simulator component(s) 806. As such, because the vehicle hardware 804 may be configured for installation within the vehicle, the simulation system 800A may be specifically configured to use the vehicle hardware 804 within a node (e.g., of a server platform, such as the ego-machine computing device 212 of FIG. 2) of the simulation system 800A. For example, interfaces used in a physical real-world vehicle may need to be used by the vehicle simulator component(s) 806 to communicate with the vehicle hardware 804. In some examples, the interfaces may include: (1) CAN interfaces, including a PCAN adapter, (2) Ethernet interfaces, including RAW UDP sockets with IP address, origin, VLA, and/or source IP all preserved, (3) Serial interfaces, with a USB to serial adapter, (4) camera interfaces, (5) InfiniBand (IB) interfaces, and/or other interface types.

In any examples, once the sensor data representative of a field(s) of view of the sensor(s) of the vehicle in the simulated environment 810 has been generated and/or processed (e.g., using one or more codecs, as described herein), the sensor data (and/or encoded sensor data) may be used by software stack(s) (e.g., an autonomous driving software stack) executed on the vehicle hardware 804 to perform one or more operations (e.g., generate one or more controls, route planning, detecting objects, identifying drivable free-space, monitoring the environment for obstacle avoidance, etc.). As a result, the identical, or substantially identical, hardware components used by the vehicle (e.g., a physical real-world vehicle) to execute the autonomous driving software stack in real-world environments may be used to execute the autonomous driving software stack in the simulated environment 810. The use of the vehicle hardware 804 in the simulation system 800A thus provides for a more accurate simulation of how the vehicle 802 will perform in real-world situations, scenarios, and environments without having to actually find and test the vehicle in the real-world. This may reduce the amount of driving time required for testing the hardware/software combination used in the physical vehicle and may reduce safety risks by not requiring actual real-world testing (especially for dangerous situations, such as other vehicles driving erratically or at unsafe speeds, children playing in the street, ice on a bridge, etc.).

In addition to the vehicle hardware 804, the vehicle simulator component(s) 806 may manage the simulation of the vehicle (or other object) using additional hardware, such as a computer—e.g., an X86 box or the ego-machine computing device 212 of FIG. 2. In some examples, additional processing for virtual sensors (e.g., learned sensor models) of the virtual object may be executed using the vehicle simulation component(s) 806. In such examples, at least some of the processing may be performed by the simulator component(s) 802, and other of the processing may be executed by the vehicle simulator component(s) 806 (or 820, or 822, as described herein). In other examples, the processing of the virtual sensors may be executed entirely on the vehicle simulator component(s) 406.

Now referring to FIG. 8B, FIG. 8B is another example illustration of a simulation system 800B, in accordance with some embodiments of the present disclosure. The simulation system 800B may include the simulator component(s) 802 (as one or more compute nodes), the vehicle simulator component(s) 806 (as one or more compute nodes) for a HIL object(s), the vehicle simulator component(s) 820 (as one or more compute nodes) for a SIL object(s), the vehicle simulator component(s) 806 (as one or more compute nodes) for a PIL object(s), and/or additional component(s) (or compute nodes) for AI objects and/or other object types. Each of the PIL, HIL, SIL, AI, and/or other object type compute nodes may communicate with the simulator component(s) 802 to capture from the global simulation at least data that corresponds to the respective object within the simulate environment 810.

For example, the vehicle simulator component(s) 822 may receive (e.g., retrieve, obtain, etc.), from the global simulation (e.g., represented by the simulated environment 810) hosted by the simulator component(s) 802, data that corresponds to, is associated with, and/or is required by the vehicle simulator component(s) 822 to perform one or more operations by the vehicle simulator component(s) 822 for the PIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the PIL object may be received from the simulator component(s) 802. This data may be used to generate an instance of the simulated environment corresponding to the field of view of a remote operator of the virtual vehicle controlled by the remote operator, and the portion of the simulated environment may be projected on a display (e.g., a display of a VR headset, a computer or television display, etc.) for assisting the remote operator in controlling the virtual vehicle through the simulated environment 810. The controls generated or input by the remote operator using the vehicle simulator component(s) 822 may be transmitted to the simulator component(s) 802 for updating a state of the virtual vehicle within the simulated environment 810.

As another example, the vehicle simulator component(s) 820 may receive (e.g., retrieve, obtain, etc.), from the global simulation hosted by the simulator component(s) 802, data that corresponds to, is associated with, and/or is required by the vehicle simulator component(s) 820 to perform one or more operations by the vehicle simulator component(s) 820 for the SIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the SIL object may be received from the simulator component(s) 802. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 820. In some examples, the sensor data may be encoded using one or more codecs (e.g., each sensor may use its own codec, or each sensor type may use its own codec) in order to generate encoded sensor data that may be understood or familiar to an autonomous driving software stack simulated or emulated by the vehicle simulator component(s) 820. For example, a first vehicle manufacturer may use a first type of LIDAR data, a second vehicle manufacturer may use a second type of LIDAR data, etc., and thus the codecs may customize the sensor data to the types of sensor data used by the manufacturers. As a result, the simulation system 800 may be universal, customizable, and/or useable by any number of different sensor types depending on the types of sensors and the corresponding data types used by different manufacturers. In any example, the sensor data and/or encoded sensor data may be used by an autonomous driving software stack to perform one or more operations (e.g., object detection, path planning, control determinations, actuation types, etc.). For example, the sensor data and/or encoded data may be used as inputs to one or more DNNs of the autonomous driving software stack, and the outputs of the one or more DNNs may be used for updating a state of the virtual vehicle within the simulated environment 810. As such, the reliability and efficacy of the autonomous driving software stack, including one or more DNNs, may be tested, fine-tuned, verified, and/or validated within the simulated environment.

In yet another example, the vehicle simulator component(s) 806 may receive (e.g., retrieve, obtain, etc.), from the global simulation hosted by the simulator component(s) 402, data that corresponds to, is associated with, and/or is required by the vehicle simulator component(s) 806 to perform one or more operations by the vehicle simulator component(s) 806 for the HIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the HIL object may be received from the simulator component(s) 802. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 820 (e.g., using a corresponding learned sensor model). In some examples, the sensor data may be encoded using one or more codecs (e.g., each sensor may use its own codec, or each sensor type may use its own codec) in order to generate encoded sensor data that may be understood or familiar to an autonomous driving software stack executing on the vehicle hardware of the vehicle simulator component(s) 820. Similar to the SIL object described herein, the sensor data and/or encoded sensor data may be used by an autonomous driving software stack to perform one or more operations (e.g., object detection, path planning, control determinations, actuation types, etc.).

Now referring to FIG. 8C, FIG. 8C is another example illustration of a simulation system 800C, in accordance with some embodiments of the present disclosure. The simulation system 800C may include distributed shared memory (DSM) system 824, the simulator component(s) 802 (as one or more compute nodes), the vehicle simulator component(s) 806 (as one or more compute nodes) for a HIL object(s), the vehicle simulator component(s) 820 (as one or more compute nodes) for a SIL object(s), the vehicle simulator component(s) 806 (as one or more compute nodes) for a PIL object(s), and/or additional component(s) (or compute nodes) for AI objects and/or other object types (not shown). The simulation system 800C may include any number of HIL objects (e.g., each including its own vehicle simulator component(s) 806), any number of SIL objects (e.g., each including its own vehicle simulator component(s) 820), any number of PIL objects (e.g., each including its own vehicle simulator component(s) 822), and/or any number of AI objects (not shown, but may be hosted by the simulation component(s) 802 and/or separate compute nodes, depending on the embodiment).

The vehicle simulator component(s) 806 may include one or more SoC(s) 1105 (or other components) that may be configured for installation and use within a physical vehicle. As such, as described herein, the simulation system 800C may be configured to use the SoC(s) 1105 and/or other vehicle hardware 804 by using specific interfaces for communicating with the SoC(s) 1105 and/or other vehicle hardware. The vehicle simulator component(s) 820 may include one or more software instances 830 that may be hosted on one or more GPUs and/or CPUs to simulate or emulate the SoC(s) 1105. The vehicle simulator component(s) 822 may include one or more SoC(s) 826, one or more CPU(s) 828 (e.g., X86 boxes), and/or a combination thereof, in addition to the component(s) that may be used by the remote operator (e.g., keyboard, mouse, joystick, monitors, VR systems, steering wheel, pedals, in-vehicle components, such as light switches, blinkers, HMI display(s), etc., and/or other component(s)).

The simulation component(s) 802 may include any number of CPU(s) 832 (e.g., X86 boxes), GPU(s), and/or a combination thereof. The CPU(s) 832 may host the simulation software for maintaining the global simulation, and the GPU(s) 834 may be used for rendering, physics, and/or other functionality for generating the simulated environment 810.

As described herein, the simulation system 800C may include the DSM 824. The DSM 824 may use one or more distributed shared memory protocols to maintain the state of the global simulation using the state of each of the objects (e.g., HIL objects, SIL objects, PIL objects, AI objects, etc.). As such, each of the compute nodes corresponding to the vehicle simulator component(s) 806, 820, and/or 822 may be in communication with the simulation component(s) 802 via the DSM 824. By using the DSM 824 and the associated protocols, real-time simulation may be possible. For example, as opposed to how network protocols (e.g., TCP, UDP, etc.) are used in massive multiplayer online (MMO) games, the simulation system 800 may use a distributed shared memory protocol to maintain the state of the global simulation and each instance of the simulation (e.g., by each vehicle, object, and/or sensor) in real-time.

Now referring to FIG. 8D, FIG. 8D is an example illustration of a hardware-in-the-loop configuration, in accordance with some embodiments of the present disclosure. The vehicle simulator component(s) 806 may include the vehicle hardware 804, as described herein, and may include one or more computer(s) 836, one or more GPU(s) (not shown), and/or one or more CPU(s) (not shown). The computer(s) 836, GPU(s), and/or CPU(s) may manage or host the simulation software 838, or instance thereof, executing on the vehicle simulator component(s) 806. The vehicle hardware 804 may execute the software stack(s) 816 (e.g., an autonomous driving software stack, an IX software stack, etc.).

As described herein, by using the vehicle hardware 804, the other vehicle simulator component(s) 806 within the simulation environment 800 may need to be configured for communication with the vehicle hardware 804. For example, because the vehicle hardware 804 may be configured for installation within a physical vehicle, the vehicle hardware 804 may be configured to communicate over one or more connection types and/or communication protocols that are not standard in computing environments (e.g., in server-based platforms, in general-purpose computers, etc.). For example, a CAN interface, LVDS interface, USB interface, Ethernet interface, InfiniBand (IB) interface, and/or other interfaces may be used by the vehicle hardware 804 to communicate signals with other components of the physical vehicle. As such, in the simulation system 800, the vehicle simulator component(s) 806 (and/or other component(s) of the simulation system 800 in addition to, or alternative from, the vehicle simulator component(s) 806) may need to be configured for use with the vehicle hardware 804. In order to accomplish this, one or more CAN interfaces, LVDS interfaces, USB interfaces, Ethernet interfaces, and/or other interface may be used to provide for communication (e.g., over one or more communication protocols, such as LVDS) between vehicle hardware 804 and the other component(s) of the simulation system 800.

In some examples, the virtual vehicle that may correspond to the vehicle simulator component(s) 806 within the simulation system 800 may be modeled as a game object within an instance of a game engine. In addition, each of the virtual sensors of the virtual vehicle may be interfaced using sockets within the virtual vehicle's software stack(s) 816 executed on the vehicle hardware 804. In some examples, each of the virtual sensors of the virtual vehicle may include an instance of the game engine, in addition to the instance of the game engine associated with the simulation software 838 for the virtual vehicle. In examples where the vehicle simulator component(s) 806 include a plurality of GPUs, each of the sensors may be executed on a single GPU. In other examples, multiple sensors may be executed on a single GPU, or at least as many sensors as feasible to ensure real-time generation of the virtual sensor data.

Using HIL objects in the simulator system 800 may provide for a scalable solution that may simulate or emulate various driving conditions for autonomous software and hardware systems (e.g., NVIDIA's DRIVE AGX Pegasus™ compute platform and/or DRIVE PX Xavier™ compute platform). Some benefits of HIL objects may include the ability to test DNNs faster than real-time, the ability to scale verification with computing resources (e.g., rather than vehicles or test tracks), the ability to perform deterministic regression testing (e.g., the real-world environment is never the same twice, but a simulated environment can be), optimal ground truth labeling (e.g., no hand-labeling required), the ability to test scenarios difficult to produce in the real-world, rapid generation of test permutations, and the ability to test a larger space of permutations in simulation as compared to real-world.

Now referring to FIG. 8E, FIG. 8E is an example illustration of a hardware-in-the-loop configuration, in accordance with some embodiments of the present disclosure. The HIL configuration of FIG. 8E may include vehicle simulator component(s) 806, including the SoC(s) 1105, a chassis fan(s) 856 and/or water-cooling system. The HIL configuration may include a two-box solution (e.g., the simulator component(s) 802 in a first box and the vehicle simulator component(s) 806 in a second box). Using this approach may reduce the amount of space the system occupies as well as reduce the number of external cables in data centers (e.g., by including multiple components together with the SoC(s) 1105 in the vehicle simulator component(s) 806—e.g., the first box). The vehicle simulator component(s) 806 may include one or more GPUs 852 (e.g., NVIDIA QUADRO GPU(s)) that may provide, in an example, non-limiting embodiment, 8 DP/HDMI video streams that may be synchronized using sync component(s) 854 (e.g., through a QUADRO Sync II Card). These GPU(s) 852 (and/or other GPU types) may provide the sensor input to the SoC(s) 1105 (e.g., to the vehicle hardware 804). In some examples, the vehicle simulator component(s) 806 may include a network interface (e.g., one or more network interface cards (NICs) 850) that may simulate or emulate RADAR sensors, LIDAR sensors, and/or IMU sensors (e.g., by providing 8 Gigabit ports with precision time protocol (PTP) support). In addition, the vehicle simulator component(s) 806 may include an input/output (I/O) analog integrated circuit. Registered Jack (RJ) interfaces (e.g., RJ45), high speed data (HSD) interfaces, USB interfaces, pulse per second (PPS) clocks, Ethernet (e.g., 10 Gb Ethernet (GbE)) interfaces, CAN interfaces, HDMI interfaces, and/or other interface types may be used to effectively transmit and communication data between and among the various component(s) of the system.

Now referring to FIG. 8F, FIG. 8F is an example illustration of a software-in-the-loop configuration, in accordance with some embodiments of the present disclosure. The vehicle simulator component(s) 820 may include computer(s) 840, GPU(s) (not shown), CPU(s) (not shown), and/or other components. The computer(s) 840, GPU(s), and/or CPU(s) may manage or host the simulation software 838, or instance thereof, executing on the vehicle simulator component(s) 820, and may host the software stack(s) 116. For example, the vehicle simulator component(s) 820 may simulate or emulate, using software, the vehicle hardware 804 in an effort to execute the software stack(s) 816 as accurately as possible.

In order to increase accuracy in SIL embodiments, the vehicle simulator component(s) 820 may be configured to communicate over one or more virtual connection types and/or communication protocols that are not standard in computing environments. For example, a virtual CAN interface, virtual LVDS interface, virtual USB interface, virtual Ethernet interface, and/or other virtual interfaces may be used by the computer(s) 440, CPU(s), and/or GPU(s) of the vehicle simulator component(s) 820 to provide for communication (e.g., over one or more communication protocols, such as LVDS) between the software stack(s) 816 and the simulation software 838 within the simulation system 800. For example, the virtual interfaces may include middleware that may be used to provide a continuous feedback loop with the software stack(s) 816. As such, the virtual interfaces may simulate or emulate the communications between the vehicle hardware 804 and the physical vehicle using one or more software protocols, hardware (e.g., CPU(s), GPU(s), computer(s) 440, etc.), or a combination thereof.

The computer(s) 840 in some examples, may include X86 CPU hardware, and one or more X86 CPUs may execute both the simulation software 838 and the software stack(s) 816. In other examples, the computer(s) 840 may include GPU hardware (e.g., an NVIDIA DGX system and/or cloud-based NVIDIA Tesla servers).

In some examples, the virtual vehicle that may correspond to the vehicle simulator component(s) 820 within the simulation system 800 may be modeled as a game object within an instance of a game engine. In addition, each of the virtual sensors of the virtual vehicle may be interfaced using sockets within the virtual vehicle's software stack(s) 816 executed on the vehicle simulator component(s) 820. In some examples, each of the virtual sensors of the virtual vehicle may include an instance of the game engine, in addition to the instance of the game engine associated with the simulation software 838 for the virtual vehicle. In examples where the vehicle simulator component(s) 806 include a plurality of GPUs, each of the sensors may be executed on a single GPU. In other examples, multiple sensors may be executed on a single GPU, or at least as many sensors as feasible to ensure real-time generation of the virtual sensor data.

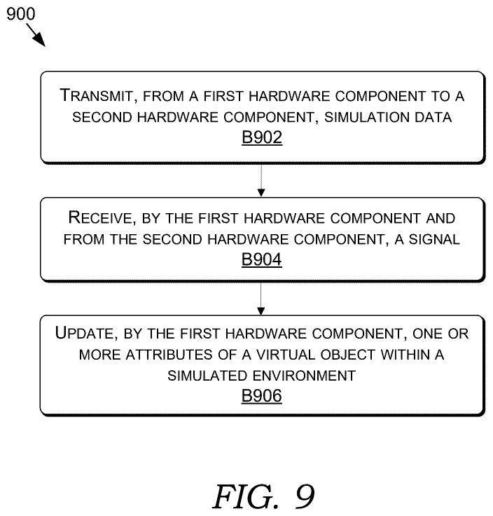

Now referring to FIG. 9, each block of method 900, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 900 is described, by way of example, with respect to the simulation system 800 of FIGS. 8A-8C. However, the method may additionally or alternatively be executed by any one system, or any combination of systems, including, but not limited to, those described herein.

FIG. 9 is a flow diagram showing a method 900 for generating a simulated environment using a hardware-in-the-loop object, in accordance with some embodiments of the present disclosure. The method 900, at block B902, includes transmitting, from a first hardware component to a second hardware component, simulation data. For example, simulation component(s) 802 may transmit simulation data to one or more of the vehicle simulator component(s) 806, the vehicle simulator component(s) 820, and/or the vehicle simulator component(s) 822. In some examples, the simulation data may be representative of at least a portion of the simulated environment 810 hosted by the simulation component(s) 802, and may correspond to the simulated environment 810 with respect to at least one virtual sensor (e.g., implemented using a learned sensor model) of a virtual object (e.g., a HIL object, a SIL object, a PIL object, and/or an AI object). In an example where the virtual sensor is a virtual camera, the simulation data may correspond to at least the data from the simulation necessary to generate a field of view of the virtual camera within the simulated environment 810.

The method 900, at block B904, includes receiving a signal by the first hardware component and from the second hardware component. For example, the simulator component(s) 802 may receive a signal from one of the vehicle simulator component(s) 806, the vehicle simulator component(s) 820, and/or the vehicle simulator component(s) 822. The signal may be representative of an operation (e.g., control, path planning, object detection, etc.) corresponding to a virtual object (e.g., a HIL object, a SIL object, a PIL object, and/or an AI object) as determined by a software stack(s) 816 (e.g., based at least in part on the virtual sensor data). In some examples, such as where the virtual object is a HIL object, the signal (or data represented thereby) may be transmitted from the vehicle hardware 804 to one or more other vehicle simulator component(s) 806, and then the vehicle simulator component(s) 806 may transmit the signal to the simulator component(s) 802. In such examples, the signals between the vehicle simulator component(s) 806 (e.g., between the vehicle hardware 804 and one or more GPU(s), CPU(s), and/or computer(s) 836) may be transmitted via a CAN interface, a USB interface, an LVDS interface, an Ethernet interface, and/or another interface. In another example, such as where the virtual object is a SIL object, the signal (or data represented thereby) may be transmitted from the vehicle simulator component(s) 820 to the simulator component(s) 802, where the data included in the signal may be generated by the software stack(s) 816 executing on simulated or emulated vehicle hardware 804. In such examples, the vehicle simulator component(s) 820 may use a virtual CAN, a virtual LVDS interface, a virtual USB interface, a virtual Ethernet interface, and/or other virtual interfaces.

The method 900, at block B906, includes updating, by the first hardware component, one or more attributes of a virtual object within a simulated environment. For example, based at least in part on the signal received from the vehicle simulator component(s) 806, the vehicle simulator component(s) 820, and/or the vehicle simulator component(s) 822, the simulator component(s) 802 may update the global simulation (and the simulated environment may be updated accordingly). In some examples, the data represented by the signal may be used to update a location, orientation, speed, and/or other attributes of the virtual object hosted by the vehicle simulator component(s) 806, the vehicle simulator component(s) 820, and/or the vehicle simulator component(s) 822.

Now referring to FIG. 10A, FIG. 10A is an example illustration of a simulation system 1000 at runtime, in accordance with some embodiments of the present disclosure. Some or all of the components of the simulation system 1000 may be used in the simulation system 800, and some or all of the components of the simulation system 800 may be used in the simulation system 800 (e.g., to produce the simulation environment 810). As such, components, features, and/or functionality described with respect to the simulation system 800 may be associated with the simulation system 1000, and vice versa. In addition, each of the simulation systems 1000A and 1000B (FIG. 10B) may include similar and/or shared components, features, and/or functionality.

The simulation system 1000A (e.g., representing one example of simulation system 1000) may include the simulator component(s) 802, codec(s) 1014, content data store(s) 1002, scenario data store(s) 1004, vehicle simulator component(s) 820 (e.g., for a SIL object), and vehicle simulator component(s) 806 (e.g., for a HIL object). The content data store(s) 1002 may include detailed content information for modeling cars, trucks, people, bicyclists, signs, buildings, trees, curbs, and/or other features of the simulated environment. The scenario data store(s) 1004 may include scenario information that may include dangerous scenario information (e.g., that is unsafe to test in the real-world environment), such as a child in an intersection.

The simulator component(s) 802 may include an AI engine 1008 that simulates traffic, pedestrians, weather, and/or other AI features of the simulated environment. The simulator component(s) 1002 may include a virtual world manager 1010 that manages the world state for the global simulation. The simulator component(s) 802 may further include a virtual sensor manger 1012 that may mange the virtual sensors (any or all of which may be implemented using a corresponding learned sensor model). The AI engine 1008 may model traffic similar to how traffic is modeled in an automotive video game (e.g., via scene authoring to produce the scene data 204 of FIG. 2), and may be done using a game engine, as described herein. In other examples, custom AI may be used to provide the determinism and computational level of detail necessary for large-scale reproducible automotive simulation. In some examples, traffic may be modeled using SIL objects, HIL objects, PIL objects, AI objects, and/or combination thereof. The system 1000 may create a subclass of an AI controller that examines map data, computes a route, and drives the route while avoiding other cars. The AI controller may compute desired steering, acceleration, and/or braking, and may apply those values to the virtual objects. The vehicle properties used may include mass, max RPM, torque curves, and/or other properties. A physics engine may be used to determine states of AI objects. As described herein, for vehicles or other objects that may be far away and may not have an impact on a current sensor(s), the system may choose not to apply physics for those objects and only determine locations and/or instantaneous motion vectors. Ray-casting may be used for each wheel to ensure that the wheels of the vehicles are in contact. In some examples, traffic AI may operate according to a script (e.g., rules-based traffic). Traffic AI maneuvers for virtual objects may include lateral lane changes (e.g., direction, distance, duration, shape, etc.), longitudinal movement (e.g., matching speed, relative target, delta to target, absolute value), route following, and/or path following. The triggers for the traffic AI maneuvers may be time-based (e.g., three seconds), velocity-based (e.g., at sixty mph), proximity-based to map (e.g., within twenty feet of intersection), proximity-based to actor (e.g., within twenty feet of another object), lane clear, and/or others.

The AI engine 1008 may model pedestrian AI similar to traffic AI, described herein, but for pedestrians. The pedestrians may be modeled similar to real pedestrians, and the system 1000 may infer pedestrian conduct based on learned behaviors.

The simulator component(s) 802 may be used to adjust the time of day such that street lights turn on and off, headlights turn on and off, shadows, glares, and/or sunsets are considered, etc. In some examples, only lights within a threshold distance to the virtual object may be considered to increase efficiency.

Weather may be accounted for by the simulator component(s) 802 (e.g., by the virtual world manager 1010). The weather may be used to update the coefficients of friction for the driving surfaces, and temperature information may be used to update tire interaction with the driving surfaces. Where rain or snow are present, the system 1000 may generate meshes to describe where rainwater and snow may accumulate based on the structure of the scene, and the meshes may be employed when rain or snow are present in the simulation.

In some examples, as described herein, at least some of the simulator component(s) 802 may alternatively be included in the vehicle simulator component(s) 820 and/or 806. For example, the vehicle simulator component(s) 820 and/or the vehicle simulator component(s) 806 may include the virtual sensor manager 1012 for managing each of the sensors of the associated virtual object. In addition, one or more of the codecs 1014 may be included in the vehicle simulator component(s) 820 and/or the vehicle simulator component(s) 806. In such examples, the virtual sensor manager 1012 may generate sensor data corresponding to a sensor of the virtual object (e.g., using a learned sensor model), and the sensor data may be used by sensor emulator 1016 of the codec(s) 1014 to encode the sensor data according to the sensor data format or type used by the software stack(s) 816 (e.g., the software stack(s) 816 executing on the vehicle simulator component(s) 820 and/or the vehicle simulator component(s) 806).

The codec(s) 1014 may provide an interface to the software stack(s) 816. The codec(s) 1014 (and/or other codec(s) described herein) may include an encoder/decoder framework. The codec(s) 1014 may include CAN steering, throttle requests, and/or may be used to send sensor data to the software stack(s) 816 in SIL and HIL embodiments. The codec(s) 1014 may be beneficial to the simulation systems described herein (e.g., 800 and 1000). For example, as data is produced by the simulation systems 800 and 1000, the data may be transmitted to the software stack(s) 816 such that the following standards may be met. The data may be transferred to the software stack(s) 816 such that minimal impact is introduced to the software stack(s) 816 and/or the vehicle hardware 804 (in HIL embodiments). This may result in more accurate simulations as the software stack(s) 816 and/or the vehicle hardware 804 may be operating in an environment that closely resembles deployment in a real-world environment. The data may be transmitted to the software stack(s) 816 such that the simulator and/or re-simulator may be agnostic to the actual hardware configuration of the system under test. This may reduce development overhead due to bugs or separate code paths depending on the simulation configuration. The data may be transmitted to the software stack(s) 816 such that the data may match (e.g., bit-to-bit) the data sent from a physical sensor of a physical real-world vehicle. The data may be transmitted to efficiently in both SIL and HIL embodiments.

The sensor emulator 1016 may emulate at least cameras, LIDAR sensors, and/or RADAR sensors, any or all of which may be implemented using a corresponding learned sensor model. Using a learned sensor model may obviate the need to model the sensor using ray-tracing, although in some embodiments, ray-tracing may additionally or alternatively be used. With respect to LIDAR sensors, some LIDAR sensors report tracked objects. As such, for each frame represented by the virtual sensor data, the simulator component(s) 802 may create a list of all tracked objects (e.g., trees, vehicles, pedestrians, foliage, etc.) within range of the virtual object having the virtual LIDAR sensors, and may cast virtual rays toward the tracked objects. When a significant number of rays strike a tracked object, that object may be added to the report of the LIDAR data. In some examples, the LIDAR sensors may be modeled using simple ray-casting without reflection, adjustable field of view, adjustable noise, and/or adjustable drop-outs. LIDAR with moving parts, limited fields of view, and/or variable resolutions may be simulated. For example, the LIDAR sensors may be modeled as solid state LIDAR and/or as Optix-based LIDAR. In examples, using Optix-based LIDAR, the rays may bounce from water, reflective materials, and/or windows. Texture may be assigned to roads, signs, and/or vehicles to model laser reflection at the wavelengths corresponding to the textures. RADAR may be implemented similarly to LIDAR. As described herein, RADAR and/or LIDAR may be simulated using learned sensors, ray-tracing techniques, and/or otherwise.

In some examples, the vehicle simulator component(s) 806, 820, and/or 822 may include a feedback loop with the simulator component(s) 802 (and/or the component(s) that generate the virtual sensor data). The feedback loop may be used to provide information for updating the virtual sensor data capture or generation. For example, for virtual cameras, the feedback loop may be based on sensor feedback, such as changes to exposure responsive to lighting conditions (e.g., increase exposure in dim lighting conditions so that the image data may be processed by the DNNs properly). As another example, for virtual LIDAR sensors, the feedback loop may be representative of changes to energy level (e.g., to boost energy to produce more useable or accurate LIDAR data).

GNNS sensors (e.g., GPS sensors) may be simulated within the simulation space to generate real-world coordinates. In order to this, noise functions may be used to approximate inaccuracy. As with any virtual sensors described herein, the virtual sensor data may be generated using a learned sensor model or otherwise, and transmitted to the software stack(s) 816 using the codec(s) 1014 to be converted to a bit-to-bit correct signal (e.g., corresponding accurately to the signals generated by the physical sensors of the physical vehicles).

One or more plugin application programming interfaces (APIs) 1006 may be used. The plugin APIs 1006 may include first-party and/or third-party plugins. For example, third parties may customize the simulation system 1000B using their own plugin APIs 1006 for providing custom information, such as performance timings, suspension dynamics, tire dynamics, etc.

The plugin APIs 1006 may include an ego-dynamics component(s) (not shown) that may receive information from the simulator component(s) 802 including position, velocity, car state, and/or other information, and may provide information to the simulator component(s) 802 including performance timings, suspension dynamics, tire dynamics, and/or other information. For examples, the simulator component(s) 802 may provide CAN throttle, steering, and the driving surface information to the ego-dynamics component(s). In some examples, the ego-dynamics component(s) may include an off-the-shelf vehicle dynamics package (e.g., IPG CARMAKER or VIRTUAL TEST DRIVE), while in other examples the ego-dynamics component(s) may be customized and/or received (e.g., from a first-party and/or a third-party).

The plugin APIs 1006 may include a key performance indicator (KPI) API. The KPI API may receive CAN data, ground truth, and/or virtual object state information (e.g., from the software stack(s) 816) from the simulator component(s) 802 and may generate and/or provide a report (in real-time) that includes KPI's and/or commands to save state, restore state, and/or apply changes.

Now referring to FIG. 10B, FIG. 10B includes a cloud-based architecture for a simulation system 1000B, in accordance with some embodiment of the present disclosure. The simulation system 1000B may, at least partly, reside in the cloud and may communicate over one or more networks, such as but not limited to those described herein (e.g., over the network interface 206 of FIG. 2), with one or more GPU platforms 1024 (e.g., that may include GPUs, CPUs, TPUS, and/or other processor types) and/or one or more HIL platforms 1026 (e.g., which may include some or all of the components from the vehicle simulator component(s) 806, described herein).

A simulated environment 1028 (e.g., which may be similar to the simulated environment 810 described herein) may be modeled by interconnected components including a simulation engine 1030, an AI engine 1032, a global illumination (GI) engine 1034, an asset data store(s) 1036, and/or other components. In some examples, these component(s) may be used to model a simulated environment (e.g., a virtual world) in a virtualized interactive platform (e.g., similar to a massive multiplayer online (MMO) game environment. The simulated environment may further include physics, traffic simulation, weather simulation, and/or other features and simulations for the simulated environment. GI engine 1034 may calculate GI once and share the calculation with each of the nodes 1018(1)-1018(N) and 1020(1)-1020(N) (e.g., the calculation of GI may be view independent). The simulated environment 1028 may include an AI universe 1022 that provides data to GPU platforms 1024 (e.g., GPU servers) that may create renderings for each sensor of the vehicle (e.g., at the virtual sensor/codec(s) 1018 for a first virtual object and at the virtual sensor codec(s) 1020 for a second virtual object). For example, the GPU platform 1024 may receive data about the simulated environment 1028 and may create sensor inputs for each of 1018(1)-1018(N), 1020(1)-1020(N), and/or virtual sensor/codec pairs corresponding to other virtual objects (depending on the embodiment). In examples where the virtual objects are simulated using HIL objects, the sensor inputs may be provided to the vehicle hardware 804 which may use the software stack(s) 816 to perform one or more operations and/or generate one or more commands, such as those described herein. In some examples, as described herein, the virtual sensor data from each of the virtual sensors may be encoded using a codec prior to being used by (or transmitted to) the software stack(s) 816. In addition, in some examples, each of the sensors may be executed on its own GPU within the GPU platform 1024, while in other examples, two or more sensors may share the same GPU within the GPU platform 1024.

The one or more operations or commands may be transmitted to the simulation engine 1030 which may update the behavior of one or more of the virtual objects based on the operations and/or commands. For example, the simulation engine 1030 may use the AI engine 1032 to update the behavior of the AI agents as well as the virtual objects in the simulated environment 1028. The simulation engine 1030 may then update the object data and characteristics (e.g., within the asset data store(s) 1036), may update the GI (and/or other aspects such as reflections, shadows, etc.), and then may generate and provide updated sensor inputs to the GPU platform 1024. This process may repeat until a simulation is completed.

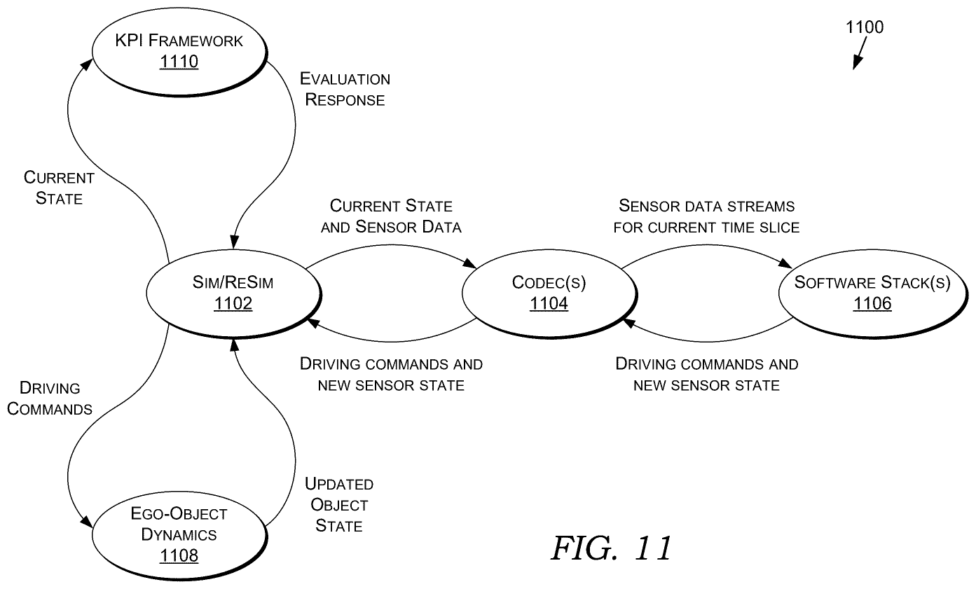

Now referring to FIG. 11, FIG. 11 includes a data flow diagram illustrating a process 1100 for re-simulation or simulation using one or more codecs, in accordance with some embodiments of the present disclosure. The process 1100 may include a current state and/or sensor data be transmitted from the simulation and/or re-simulation to one or more codecs 104. At least some of the data (e.g., the sensor data) may then be encoded using the codec(s) 1104 and provided to the software stack(s) 1106 (e.g., similar to the software stack(s) 816) for a current time slice. The driving commands and new sensor state may then transmitted (e.g., via CAN or V-CAN) to the codec(s) 1104 and back to the simulation and/or re-simulation. The driving commands generated originally by the software stack(s) 1106 (e.g., by an autonomous driving software stack) may then be passed to ego-object dynamics which may use custom or built-in dynamics to update the object state for the particular type of virtual object being simulated and the updated object state may be passed back to the simulation and/or re-simulation. The simulation system may use the object's state, commands, and/or information, in addition to using traffic AI, pedestrian AI, and/or other features of the simulation platform, to generate or update the simulated environment (e.g., to a current state). The current state may be passed to the KPI framework (e.g., at the same time as the driving commands being passed to the ego-object dynamics 1108, in some embodiments), and the KPI framework 1110 may monitor and evaluate the current simulation and/or re-simulation. In some examples, the codec(s) 1104 may buffer simulation data to increase performance and/or reduce latency of the system.

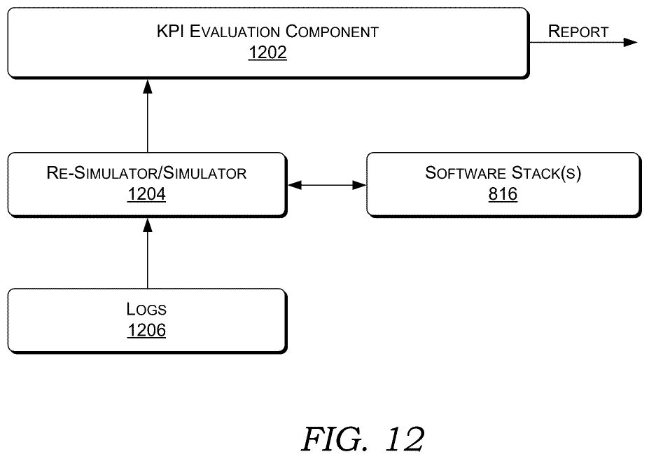

Now referring to FIG. 12, FIG. 12 includes a data flow diagram for key performance indicator (KPI) analysis and observation, in accordance with some embodiments of the present disclosure. A KPI evaluation component may evaluate the performance of the virtual object(s) (e.g., vehicles, robots, etc.). Logs 1206 may be generated and passed to re-simulator/simulator 1204. The re-simulator/simulator 1204 may provide sensor data to the software stack(s) 816 which may be executed using HIL, SIL, or a combination thereof. The KPI evaluation component 1202 may use different metrics for each simulation or re-simulation instance. For examples, for re-simulation, KPI evaluation component may provide access to the original re-played CAN data and/or the newly generated CAN data from the software stack(s) 816 (e.g., from HIL or SIL). In some examples, performance could be as simple as testing that the new CAN data does not create a false positive-such as by triggering Automatic Emergency Braking (AEB), or another ADAS functionality. For example, the KPI evaluation component 802 may determine whether the new CAN data triggers a blind spot warning, or a lane departure warning. As a result, the system may help reduce the false positives that plague conventional ADAS systems. The KPI evaluation component 802 may also determine whether the new CAN data fails to trigger a warning that should have been implemented.

In some examples, the KPI evaluation component 802 may also provide for more complex comparisons. For example, the KPI evaluation component 802 may be as complex as running analytics on the two differing CAN streams to find deviations. The KPI evaluation component 1202 may compare the new CAN data against the original CAN data, and may evaluate both trajectories to determine which trajectory would best meet the systems safety goals. In some examples, the KPI evaluation component 1202 may use one or more methods described in U.S. Provisional Application No. 62/625,351, or U.S. Non-Provisional patent application Ser. No. 16/256,780, each hereby incorporated by reference in its entirety. In other examples, the KPI Evaluation component 1202 may use one or of the methods described in U.S. Provisional Application No. 62/628,831, or U.S. Non-Provisional patent application Ser. No. 16/269,921, each hereby incorporated by reference in its entirety. For example, safety procedures may be determined based on safe time of arrival calculations.

In some examples, the KPI evaluation component 1202 may also use the method described in U.S. Provisional Application No. 62/622,538 or U.S. Non-Provisional patent application Ser. No. 16/258,272, hereby incorporated by reference in its entirety, which may be used to detect hazardous driving using machine learning. For example, machine learning and deep neural networks (DNNs) may be used for redundancy and for path checking e.g., for a rationality checker as part of functional safety for autonomous driving. These techniques may be extended for use with the KPI evaluation component 1202 to evaluate the performance of the system.

The KPI Evaluation component may also use additional approaches to assess the performance of the system. For example, the KPI evaluation component 1202 may consider whether the time to arrival (TTA) in the path of the cross-traffic is less than a threshold time—e.g. two seconds. The threshold may vary depending on the speed of the vehicle, road conditions, weather, traffic, and/or other variables. For example, the threshold duration may be two seconds for speeds up to twenty MPH, and one second for any greater speed. Alternatively, the threshold duration may be reduced or capped whenever the system detects hazardous road conditions such as wet roads, ice, or snow. In some examples, hazardous road conditions may be detected by a DNN trained to detect such conditions.

With respect to simulation, the KPI evaluation component may include an API, as described herein. The KPI evaluation component 1202 may include additional inputs and/or provide more functionality. For example, the simulator may be able to share the “ground truth” for the scene, and may be able to determine the capability of the virtual object with respect to avoiding collisions, staying-in-lane, and/or performing other behaviors. For examples, the KPI evaluation component 1202 may be more than a passive witness to the experiment, and may include an API to save the state of any ongoing simulation, change state or trigger behaviors, and continue with those changes. This may allow the KPI evaluation component to not only evaluate the car performance but to try to explore the space of potential dangerous scenarios.

### Example Autonomous Vehicle

FIG. 13A is an illustration of an example autonomous vehicle 1300, in accordance with some embodiments of the present disclosure. The autonomous vehicle 1300 (alternatively referred to herein as the “vehicle 1300”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1300 may be capable of functionality in accordance with one or more of Level 3-Level 5 of the autonomous driving levels. The vehicle 1300 may be capable of functionality in accordance with one or more of Level 1-Level 5 of the autonomous driving levels. For example, the vehicle 1300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1300 or other machine, such as being fully autonomous, being highly autonomous, being conditionally autonomous, being partially autonomous, providing assistive autonomy, being semi-autonomous, being primarily autonomous, or other designation.

The vehicle 1300 may include components such as a chassis, a vehicle body, wheels (e.g., 2, 4, 6, 8, 18, etc.), tires, axles, and other components of a vehicle. The vehicle 1300 may include a propulsion system 1350, such as an internal combustion engine, hybrid electric power plant, an all-electric engine, and/or another propulsion system type. The propulsion system 1350 may be connected to a drive train of the vehicle 1300, which may include a transmission, to enable the propulsion of the vehicle 1300. The propulsion system 1350 may be controlled in response to receiving signals from the throttle/accelerator 1352.

A steering system 1354, which may include a steering wheel, may be used to steer the vehicle 1300 (e.g., along a desired path or route) when the propulsion system 1350 is operating (e.g., when the vehicle is in motion). The steering system 1354 may receive signals from a steering actuator 1356. The steering wheel may be optional for full automation (Level 5) functionality.

The brake sensor system 1346 may be used to operate the vehicle brakes in response to receiving signals from the brake actuators 1348 and/or brake sensors.

Controller(s) 1336, which may include one or more system on chips (SoCs) 1304 (FIG. 13C) and/or GPU(s), may provide signals (e.g., representative of commands) to one or more components and/or systems of the vehicle 1300. For example, the controller(s) may send signals to operate the vehicle brakes via one or more brake actuators 1348, to operate the steering system 1354 via one or more steering actuators 1356, to operate the propulsion system 1350 via one or more throttle/accelerators 1352. The controller(s) 1336 may include one or more onboard (e.g., integrated) computing devices (e.g., supercomputers) that process sensor signals, and output operation commands (e.g., signals representing commands) to enable autonomous driving and/or to assist a human driver in driving the vehicle 1300. The controller(s) 1336 may include a first controller 1336 for autonomous driving functions, a second controller 1336 for functional safety functions, a third controller 1336 for artificial intelligence functionality (e.g., computer vision), a fourth controller 1336 for infotainment functionality, a fifth controller 1336 for redundancy in emergency conditions, and/or other controllers. In some examples, a single controller 1336 may handle two or more of the above functionalities, two or more controllers 1336 may handle a single functionality, and/or any combination thereof.

The controller(s) 1336 may provide the signals for controlling one or more components and/or systems of the vehicle 1300 in response to sensor data received from one or more sensors (e.g., sensor inputs). The sensor data may be received from, for example and without limitation, global navigation satellite systems (“GNSS”) sensor(s) 1358 (e.g., Global Positioning System sensor(s)), RADAR sensor(s) 1360, ultrasonic sensor(s) 1362, LIDAR sensor(s) 1364, inertial measurement unit (IMU) sensor(s) 1366 (e.g., accelerometer(s), gyroscope(s), magnetic compass(es), magnetometer(s), etc.), microphone(s) 1396, stereo camera(s) 1368, wide-view camera(s) 1370 (e.g., fisheye cameras), infrared camera(s) 1372, surround camera(s) 1374 (e.g., 360 degree cameras), long-range and/or mid-range camera(s) 1398, speed sensor(s) 1344 (e.g., for measuring the speed of the vehicle 1300), vibration sensor(s) 1342, steering sensor(s) 1340, brake sensor(s) (e.g., as part of the brake sensor system 1346), one or more occupant monitoring system (OMS) sensor(s) 1301 (e.g., one or more interior cameras), and/or other sensor types.

One or more of the controller(s) 1336 may receive inputs (e.g., represented by input data) from an instrument cluster 1332 of the vehicle 1300 and provide outputs (e.g., represented by output data, display data, etc.) via a human-machine interface (HMI) display 1334, an audible annunciator, a loudspeaker, and/or via other components of the vehicle 1300. The outputs may include information such as vehicle velocity, speed, time, map data (e.g., the High Definition (“HD”) map 1322 of FIG. 13C), location data (e.g., the vehicle's 1300 location, such as on a map), direction, location of other vehicles (e.g., an occupancy grid), information about objects and status of objects as perceived by the controller(s) 1336, etc. For example, the HMI display 1334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1300 further includes a network interface 1324 which may use one or more wireless antenna(s) 1326 and/or modem(s) to communicate over one or more networks. For example, the network interface 1324 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1326 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 13B is an example of camera locations and fields of view for the example autonomous vehicle 1300 of FIG. 13A, in accordance with some embodiments of the present disclosure. The cameras and respective fields of view are one example embodiment and are not intended to be limiting. For example, additional and/or alternative cameras may be included and/or the cameras may be located at different locations on the vehicle 1300.

The camera types for the cameras may include, but are not limited to, digital cameras that may be adapted for use with the components and/or systems of the vehicle 1300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1300 (e.g., front-facing cameras) may be used for surround view, to help identify forward facing paths and obstacles, as well aid in, with the help of one or more controllers 1336 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1370 that may be used to perceive objects coming into view from the periphery (e.g., pedestrians, crossing traffic or bicycles). Although only one wide-view camera is illustrated in FIG. 13B, there may be any number (including zero) of wide-view cameras 1370 on the vehicle 1300. In addition, any number of long-range camera(s) 1398 (e.g., a long-view stereo camera pair) may be used for depth-based object detection, especially for objects for which a neural network has not yet been trained. The long-range camera(s) 1398 may also be used for object detection and classification, as well as basic object tracking.

Any number of stereo cameras 1368 may also be included in a front-facing configuration. In at least one embodiment, one or more of stereo camera(s) 1368 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1368 may be used in addition to, or alternatively from, those described herein.

Cameras with a field of view that include portions of the environment to the side of the vehicle 1300 (e.g., side-view cameras) may be used for surround view, providing information used to create and update the occupancy grid, as well as to generate side impact collision warnings. For example, surround camera(s) 1374 (e.g., four surround cameras 1374 as illustrated in FIG. 13B) may be positioned to on the vehicle 1300. The surround camera(s) 1374 may include wide-view camera(s) 1370, fisheye camera(s), 360 degree camera(s), and/or the like. Four example, four fisheye cameras may be positioned on the vehicle's front, rear, and sides. In an alternative arrangement, the vehicle may use three surround camera(s) 1374 (e.g., left, right, and rear), and may leverage one or more other camera(s) (e.g., a forward-facing camera) as a fourth surround view camera.

Cameras with a field of view that include portions of the environment to the rear of the vehicle 1300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1398, stereo camera(s) 1368), infrared camera(s) 1372, etc.), as described herein.

Cameras with a field of view that include portions of the interior environment within the cabin of the vehicle 1300 (e.g., one or more OMS sensor(s) 1301) may be used as part of an occupant monitoring system (OMS) such as, but not limited to, a driver monitoring system (DMS). For example, OMS sensors (e.g., the OMS sensor(s) 1301) may be used (e.g., by the controller(s) 1336) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 13C is a block diagram of an example system architecture for the example autonomous vehicle 1300 of FIG. 13A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1300 in FIG. 13C are illustrated as being connected via bus 1302. The bus 1302 may include a Controller Area Network (CAN) data interface (alternatively referred to herein as a “CAN bus”). A CAN may be a network inside the vehicle 1300 used to aid in control of various features and functionality of the vehicle 1300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1302 is described herein as being a CAN bus, this is not intended to be limiting. For example, in addition to, or alternatively from, the CAN bus, FlexRay and/or Ethernet may be used. Additionally, although a single line is used to represent the bus 1302, this is not intended to be limiting. For example, there may be any number of busses 1302, which may include one or more CAN busses, one or more FlexRay busses, one or more Ethernet busses, and/or one or more other types of busses using a different protocol. In some examples, two or more busses 1302 may be used to perform different functions, and/or may be used for redundancy. For example, a first bus 1302 may be used for collision avoidance functionality and a second bus 1302 may be used for actuation control. In any example, each bus 1302 may communicate with any of the components of the vehicle 1300, and two or more busses 1302 may communicate with the same components. In some examples, each SoC 1304, each controller 1336, and/or each computer within the vehicle may have access to the same input data (e.g., inputs from sensors of the vehicle 1300), and may be connected to a common bus, such the CAN bus.

The vehicle 1300 may include one or more controller(s) 1336, such as those described herein with respect to FIG. 13A. The controller(s) 1336 may be used for a variety of functions. The controller(s) 1336 may be coupled to any of the various other components and systems of the vehicle 1300, and may be used for control of the vehicle 1300, artificial intelligence of the vehicle 1300, infotainment for the vehicle 1300, and/or the like.

The vehicle 1300 may include a system(s) on a chip (SoC) 1304. The SoC 1304 may include CPU(s) 1306, GPU(s) 1308, processor(s) 1310, cache(s) 1312, accelerator(s) 1314, data store(s) 1316, and/or other components and features not illustrated. The SoC(s) 1304 may be used to control the vehicle 1300 in a variety of platforms and systems. For example, the SoC(s) 1304 may be combined in a system (e.g., the system of the vehicle 1300) with an HD map 1322 which may obtain map refreshes and/or updates via a network interface 1324 from one or more servers (e.g., server(s) 1378 of FIG. 13D).

The CPU(s) 1306 may include a CPU cluster or CPU complex (alternatively referred to herein as a “CCPLEX”). The CPU(s) 1306 may include multiple cores and/or L2 caches. For example, in some embodiments, the CPU(s) 1306 may include eight cores in a coherent multi-processor configuration. In some embodiments, the CPU(s) 1306 may include four dual-core clusters where each cluster has a dedicated L2 cache (e.g., a 2 MB L2 cache). The CPU(s) 1306 (e.g., the CCPLEX) may be configured to support simultaneous cluster operation enabling any combination of the clusters of the CPU(s) 1306 to be active at any given time.

The CPU(s) 1306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1308 may include an integrated GPU (alternatively referred to herein as an “iGPU”). The GPU(s) 1308 may be programmable and may be efficient for parallel workloads. The GPU(s) 1308, in some examples, may use an enhanced tensor instruction set. The GPU(s) 1308 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1308 may include at least eight streaming microprocessors. The GPU(s) 1308 may use compute application programming interface(s) (API(s)). In addition, the GPU(s) 1308 may use one or more parallel computing platforms and/or programming models (e.g., NVIDIA's CUDA).

The GPU(s) 1308 may be power-optimized for best performance in automotive and embedded use cases. For example, the GPU(s) 1308 may be fabricated on a Fin field-effect transistor (FinFET). However, this is not intended to be limiting and the GPU(s) 1308 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1308 to access the CPU(s) 1306 page tables directly. In such examples, when the GPU(s) 1308 memory management unit (MMU) experiences a miss, an address translation request may be transmitted to the CPU(s) 1306. In response, the CPU(s) 1306 may look in its page tables for the virtual-to-physical mapping for the address and transmits the translation back to the GPU(s) 1308. As such, unified memory technology may allow a single unified virtual address space for memory of both the CPU(s) 1306 and the GPU(s) 1308, thereby simplifying the GPU(s) 1308 programming and porting of applications to the GPU(s) 1308.

In addition, the GPU(s) 1308 may include an access counter that may keep track of the frequency of access of the GPU(s) 1308 to memory of other processors. The access counter may help ensure that memory pages are moved to the physical memory of the processor that is accessing the pages most frequently.

The SoC(s) 1304 may include any number of cache(s) 1312, including those described herein. For example, the cache(s) 1312 may include an L3 cache that is available to both the CPU(s) 1306 and the GPU(s) 1308 (e.g., that is connected both the CPU(s) 1306 and the GPU(s) 1308). The cache(s) 1312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1304 may include an arithmetic logic unit(s) (ALU(s)) which may be leveraged in performing processing with respect to any of the variety of tasks or operations of the vehicle 1300—such as processing DNNs. In addition, the SoC(s) 1304 may include a floating point unit(s) (FPU(s))—or other math coprocessor or numeric coprocessor types—for performing mathematical operations within the system. For example, the SoC(s) 1304 may include one or more FPUs integrated as execution units within a CPU(s) 1306 and/or GPU(s) 1308.

The SoC(s) 1304 may include one or more accelerators 1314 (e.g., hardware accelerators, software accelerators, or a combination thereof). For example, the SoC(s) 1304 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1308 and to off-load some of the tasks of the GPU(s) 1308 (e.g., to free up more cycles of the GPU(s) 1308 for performing other tasks). As an example, the accelerator(s) 1314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1308, and by using an inference accelerator, for example, a designer may target either the DLA(s) or the GPU(s) 1308 for any function. For example, the designer may focus processing of CNNs and floating point operations on the DLA(s) and leave other functions to the GPU(s) 1308 and/or other accelerator(s) 1314.

The accelerator(s) 1314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1314 (e.g., the hardware acceleration cluster) may include a computer vision network on-chip and SRAM, for providing a high-bandwidth, low latency SRAM for the accelerator(s) 1314. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1304 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1366 output that correlates with the vehicle 1300 orientation, distance, 3D location estimates of the object obtained from the neural network and/or other sensors (e.g., LIDAR sensor(s) 1364 or RADAR sensor(s) 1360), among others.

The SoC(s) 1304 may include data store(s) 1316 (e.g., memory). The data store(s) 1316 may be on-chip memory of the SoC(s) 1304, which may store neural networks to be executed on the GPU and/or the DLA. In some examples, the data store(s) 1316 may be large enough in capacity to store multiple instances of neural networks for redundancy and safety. The data store(s) 1316 may comprise L2 or L3 cache(s) 1312. Reference to the data store(s) 1316 may include reference to the memory associated with the PVA, DLA, and/or other accelerator(s) 1314, as described herein.

The SoC(s) 1304 may include one or more processor(s) 1310 (e.g., embedded processors). The processor(s) 1310 may include a boot and power management processor that may be a dedicated processor and subsystem to handle boot power and management functions and related security enforcement. The boot and power management processor may be a part of the SoC(s) 1304 boot sequence and may provide runtime power management services. The boot power and management processor may provide clock and voltage programming, assistance in system low power state transitions, management of SoC(s) 1304 thermals and temperature sensors, and/or management of the SoC(s) 1304 power states. Each temperature sensor may be implemented as a ring-oscillator whose output frequency is proportional to temperature, and the SoC(s) 1304 may use the ring-oscillators to detect temperatures of the CPU(s) 1306, GPU(s) 1308, and/or accelerator(s) 1314. If temperatures are determined to exceed a threshold, the boot and power management processor may enter a temperature fault routine and put the SoC(s) 1304 into a lower power state and/or put the vehicle 1300 into a chauffeur to safe stop mode (e.g., bring the vehicle 1300 to a safe stop).

The processor(s) 1310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1310 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1310 may further include a real-time camera engine that may include a dedicated processor subsystem for handling real-time camera management.

The processor(s) 1310 may further include a high-dynamic range signal processor that may include an image signal processor that is a hardware engine that is part of the camera processing pipeline.

The processor(s) 1310 may include a video image compositor that may be a processing block (e.g., implemented on a microprocessor) that implements video post-processing functions needed by a video playback application to produce the final image for the player window. The video image compositor may perform lens distortion correction on wide-view camera(s) 1370, surround camera(s) 1374, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1308 is not required to continuously render new surfaces. Even when the GPU(s) 1308 is powered on and active doing 3D rendering, the video image compositor may be used to offload the GPU(s) 1308 to improve performance and responsiveness.

The SoC(s) 1304 may further include a mobile industry processor interface (MIPI) camera serial interface for receiving video and input from cameras, a high-speed interface, and/or a video input block that may be used for camera and related pixel input functions. The SoC(s) 1304 may further include an input/output controller(s) that may be controlled by software and may be used for receiving I/O signals that are uncommitted to a specific role.

The SoC(s) 1304 may further include a broad range of peripheral interfaces to enable communication with peripherals, audio codecs, power management, and/or other devices. The SoC(s) 1304 may be used to process data from cameras (e.g., connected over Gigabit Multimedia Serial Link and Ethernet), sensors (e.g., LIDAR sensor(s) 1364, RADAR sensor(s) 1360, etc. that may be connected over Ethernet), data from bus 1302 (e.g., speed of vehicle 1300, steering wheel position, etc.), data from GNSS sensor(s) 1358 (e.g., connected over Ethernet or CAN bus). The SoC(s) 1304 may further include dedicated high-performance mass storage controllers that may include their own DMA engines, and that may be used to free the CPU(s) 1306 from routine data management tasks.

The SoC(s) 1304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1304 may be faster, more reliable, and even more energy-efficient and space-efficient than conventional systems. For example, the accelerator(s) 1314, when combined with the CPU(s) 1306, the GPU(s) 1308, and the data store(s) 1316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1308.

In some examples, a CNN for facial recognition and vehicle owner identification may use data from camera sensors to identify the presence of an authorized driver and/or owner of the vehicle 1300. The always on sensor processing engine may be used to unlock the vehicle when the owner approaches the driver door and turn on the lights, and, in security mode, to disable the vehicle when the owner leaves the vehicle. In this way, the SoC(s) 1304 provide for security against theft and/or carjacking.

In another example, a CNN for emergency vehicle detection and identification may use data from microphones 1396 to detect and identify emergency vehicle sirens. In contrast to conventional systems, that use general classifiers to detect sirens and manually extract features, the SoC(s) 1304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1362, until the emergency vehicle(s) passes.

The vehicle may include a CPU(s) 1318 (e.g., discrete CPU(s), or dCPU(s)), that may be coupled to the SoC(s) 1304 via a high-speed interconnect (e.g., PCIe). The CPU(s) 1318 may include an X86 processor, for example. The CPU(s) 1318 may be used to perform any of a variety of functions, including arbitrating potentially inconsistent results between ADAS sensors and the SoC(s) 1304, and/or monitoring the status and health of the controller(s) 1336 and/or infotainment SoC 1330, for example.

The vehicle 1300 may include a GPU(s) 1320 (e.g., discrete GPU(s), or dGPU(s)), that may be coupled to the SoC(s) 1304 via a high-speed interconnect (e.g., NVIDIA's NVLINK). The GPU(s) 1320 may provide additional artificial intelligence functionality, such as by executing redundant and/or different neural networks, and may be used to train and/or update neural networks based on input (e.g., sensor data) from sensors of the vehicle 1300.

The vehicle 1300 may further include the network interface 1324 which may include one or more wireless antennas 1326 (e.g., one or more wireless antennas for different communication protocols, such as a cellular antenna, a Bluetooth antenna, etc.). The network interface 1324 may be used to enable wireless connectivity over the Internet with the cloud (e.g., with the server(s) 1378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1300 information about vehicles in proximity to the vehicle 1300 (e.g., vehicles in front of, on the side of, and/or behind the vehicle 1300). This functionality may be part of a cooperative adaptive cruise control functionality of the vehicle 1300.

The network interface 1324 may include a SoC that provides modulation and demodulation functionality and enables the controller(s) 1336 to communicate over wireless networks. The network interface 1324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1300 may further include data store(s) 1328 which may include off-chip (e.g., off the SoC(s) 1304) storage. The data store(s) 1328 may include one or more storage elements including RAM, SRAM, DRAM, VRAM, Flash, hard disks, and/or other components and/or devices that may store at least one bit of data.

The vehicle 1300 may further include GNSS sensor(s) 1358. The GNSS sensor(s) 1358 (e.g., GPS, assisted GPS sensors, differential GPS (DGPS) sensors, etc.), to assist in mapping, perception, occupancy grid generation, and/or path planning functions. Any number of GNSS sensor(s) 1358 may be used, including, for example and without limitation, a GPS using a USB connector with an Ethernet to Serial (RS-232) bridge.

The vehicle 1300 may further include RADAR sensor(s) 1360. The RADAR sensor(s) 1360 may be used by the vehicle 1300 for long-range vehicle detection, even in darkness and/or severe weather conditions. RADAR functional safety levels may be ASIL B. The RADAR sensor(s) 1360 may use the CAN and/or the bus 1302 (e.g., to transmit data generated by the RADAR sensor(s) 1360) for control and to access object tracking data, with access to Ethernet to access raw data in some examples. A wide variety of RADAR sensor types may be used. For example, and without limitation, the RADAR sensor(s) 1360 may be suitable for front, rear, and side RADAR use. In some example, Pulse Doppler RADAR sensor(s) are used.

The RADAR sensor(s) 1360 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1300 surroundings at higher speeds with minimal interference from traffic in adjacent lanes. The other two antennae may expand the field of view, making it possible to quickly detect vehicles entering or leaving the vehicle's 1300 lane.

Mid-range RADAR systems may include, as an example, a range of up to 1360 m (front) or 80 m (rear), and a field of view of up to 42 degrees (front) or 1350 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1300 may further include ultrasonic sensor(s) 1362. The ultrasonic sensor(s) 1362, which may be positioned at the front, back, and/or the sides of the vehicle 1300, may be used for park assist and/or to create and update an occupancy grid. A wide variety of ultrasonic sensor(s) 1362 may be used, and different ultrasonic sensor(s) 1362 may be used for different ranges of detection (e.g., 2.5 m, 4 m). The ultrasonic sensor(s) 1362 may operate at functional safety levels of ASIL B.

The vehicle 1300 may include LIDAR sensor(s) 1364. The LIDAR sensor(s) 1364 may be used for object and pedestrian detection, emergency braking, collision avoidance, and/or other functions. The LIDAR sensor(s) 1364 may be functional safety level ASIL B. In some examples, the vehicle 1300 may include multiple LIDAR sensors 1364 (e.g., two, four, six, etc.) that may use Ethernet (e.g., to provide data to a Gigabit Ethernet switch).

In some examples, the LIDAR sensor(s) 1364 may be capable of providing a list of objects and their distances for a 360-degree field of view. Commercially available LIDAR sensor(s) 1364 may have an advertised range of approximately 1300 m, with an accuracy of 2 cm-3 cm, and with support for a 1300 Mbps Ethernet connection, for example. In some examples, one or more non-protruding LIDAR sensors 1364 may be used. In such examples, the LIDAR sensor(s) 1364 may be implemented as a small device that may be embedded into the front, rear, sides, and/or corners of the vehicle 1300. The LIDAR sensor(s) 1364, in such examples, may provide up to a 120-degree horizontal and 35-degree vertical field-of-view, with a 200 m range even for low-reflectivity objects. Front-mounted LIDAR sensor(s) 1364 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1300. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1364 may be less susceptible to motion blur, vibration, and/or shock.

The vehicle may further include IMU sensor(s) 1366. The IMU sensor(s) 1366 may be located at a center of the rear axle of the vehicle 1300, in some examples. The IMU sensor(s) 1366 may include, for example and without limitation, an accelerometer(s), a magnetometer(s), a gyroscope(s), a magnetic compass(es), and/or other sensor types. In some examples, such as in six-axis applications, the IMU sensor(s) 1366 may include accelerometers and gyroscopes, while in nine-axis applications, the IMU sensor(s) 1366 may include accelerometers, gyroscopes, and magnetometers.

In some embodiments, the IMU sensor(s) 1366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1366 may enable the vehicle 1300 to estimate heading without requiring input from a magnetic sensor by directly observing and correlating the changes in velocity from GPS to the IMU sensor(s) 1366. In some examples, the IMU sensor(s) 1366 and the GNSS sensor(s) 1358 may be combined in a single integrated unit.

The vehicle may include microphone(s) 1396 placed in and/or around the vehicle 1300. The microphone(s) 1396 may be used for emergency vehicle detection and identification, among other things.

The vehicle may further include any number of camera types, including stereo camera(s) 1368, wide-view camera(s) 1370, infrared camera(s) 1372, surround camera(s) 1374, long-range and/or mid-range camera(s) 1398, and/or other camera types. The cameras may be used to capture image data around an entire periphery of the vehicle 1300. The types of cameras used depends on the embodiments and requirements for the vehicle 1300, and any combination of camera types may be used to provide the necessary coverage around the vehicle 1300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 13A and FIG. 13B.

The vehicle 1300 may further include vibration sensor(s) 1342. The vibration sensor(s) 1342 may measure vibrations of components of the vehicle, such as the axle(s). For example, changes in vibrations may indicate a change in road surfaces. In another example, when two or more vibration sensors 1342 are used, the differences between the vibrations may be used to determine friction or slippage of the road surface (e.g., when the difference in vibration is between a power-driven axle and a freely rotating axle).

The vehicle 1300 may include an ADAS system 1338. The ADAS system 1338 may include a SoC, in some examples. The ADAS system 1338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1360, LIDAR sensor(s) 1364, and/or a camera(s). The ACC systems may include longitudinal ACC and/or lateral ACC. Longitudinal ACC monitors and controls the distance to the vehicle immediately ahead of the vehicle 1300 and automatically adjust the vehicle speed to maintain a safe distance from vehicles ahead. Lateral ACC performs distance keeping, and advises the vehicle 1300 to change lanes when necessary. Lateral ACC is related to other ADAS applications such as LCA and CWS.

CACC uses information from other vehicles that may be received via the network interface 1324 and/or the wireless antenna(s) 1326 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 1300), while the 12V communication concept provides information about traffic further ahead. CACC systems may include either or both 12V and V2V information sources. Given the information of the vehicles ahead of the vehicle 1300, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1300 if the vehicle 1300 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1360, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1300 is backing up. Some RCTW systems include AEB to ensure that the vehicle brakes are applied to avoid a crash. RCTW systems may use one or more rear-facing RADAR sensor(s) 1360, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1300, the vehicle 1300 itself must, in the case of conflicting results, decide whether to heed the result from a primary computer or a secondary computer (e.g., a first controller 1336 or a second controller 1336). For example, in some embodiments, the ADAS system 1338 may be a backup and/or secondary computer for providing perception information to a backup computer rationality module. The backup computer rationality monitor may run a redundant diverse software on hardware components to detect faults in perception and dynamic driving tasks. Outputs from the ADAS system 1338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1304.

In other examples, ADAS system 1338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1338 may be fed into the primary computer's perception block and/or the primary computer's dynamic driving task block. For example, if the ADAS system 1338 indicates a forward crash warning due to an object immediately ahead, the perception block may use this information when identifying objects. In other examples, the secondary computer may have its own neural network which is trained and thus reduces the risk of false positives, as described herein.

The vehicle 1300 may further include the infotainment SoC 1330 (e.g., an in-vehicle infotainment system (IVI)). Although illustrated and described as a SoC, the infotainment system may not be a SoC, and may include two or more discrete components. The infotainment SoC 1330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1300. For example, the infotainment SoC 1330 may radios, disk players, navigation systems, video players, USB and Bluetooth connectivity, carputers, in-car entertainment, Wi-Fi, steering wheel audio controls, hands free voice control, a heads-up display (HUD), an HMI display 1334, a telematics device, a control panel (e.g., for controlling and/or interacting with various components, features, and/or systems), and/or other components. The infotainment SoC 1330 may further be used to provide information (e.g., visual and/or audible) to a user(s) of the vehicle, such as information from the ADAS system 1338, autonomous driving information such as planned vehicle maneuvers, trajectories, surrounding environment information (e.g., intersection information, vehicle information, road information, etc.), and/or other information.

The infotainment SoC 1330 may include GPU functionality. The infotainment SoC 1330 may communicate over the bus 1302 (e.g., CAN bus, Ethernet, etc.) with other devices, systems, and/or components of the vehicle 1300. In some examples, the infotainment SoC 1330 may be coupled to a supervisory MCU such that the GPU of the infotainment system may perform some self-driving functions in the event that the primary controller(s) 1336 (e.g., the primary and/or backup computers of the vehicle 1300) fail. In such an example, the infotainment SoC 1330 may put the vehicle 1300 into a chauffeur to safe stop mode, as described herein.

The vehicle 1300 may further include an instrument cluster 1332 (e.g., a digital dash, an electronic instrument cluster, a digital instrument panel, etc.). The instrument cluster 1332 may include a controller and/or supercomputer (e.g., a discrete controller or supercomputer).

The instrument cluster 1332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1330 and the instrument cluster 1332. In other words, the instrument cluster 1332 may be included as part of the infotainment SoC 1330, or vice versa.

FIG. 13D is a system diagram for communication between cloud-based server(s) and the example autonomous vehicle 1300 of FIG. 13A, in accordance with some embodiments of the present disclosure. The system 1376 may include server(s) 1378, network(s) 1390, and vehicles, including the vehicle 1300. The server(s) 1378 may include a plurality of GPUs 1384(A)-1384 (H) (collectively referred to herein as GPUs 1384), PCIe switches 1382(A)-1382(D) (collectively referred to herein as PCIe switches 1382), and/or CPUs 1380(A)-1380(B) (collectively referred to herein as CPUs 1380). The GPUs 1384, the CPUs 1380, and the PCIe switches may be interconnected with high-speed interconnects such as, for example and without limitation, NVLink interfaces 1388 developed by NVIDIA and/or PCIe connections 1386. In some examples, the GPUs 1384 are connected via NVLink and/or NVSwitch SoC and the GPUs 1384 and the PCIe switches 1382 are connected via PCIe interconnects. Although eight GPUs 1384, two CPUs 1380, and two PCIe switches are illustrated, this is not intended to be limiting. Depending on the embodiment, each of the server(s) 1378 may include any number of GPUs 1384, CPUs 1380, and/or PCIe switches. For example, the server(s) 1378 may each include eight, sixteen, thirty-two, and/or more GPUs 1384.

The server(s) 1378 may receive, over the network(s) 1390 and from the vehicles, image data representative of images showing unexpected or changed road conditions, such as recently commenced road-work. The server(s) 1378 may transmit, over the network(s) 1390 and to the vehicles, neural networks 1392, updated neural networks 1392, and/or map information 1394, including information regarding traffic and road conditions. The updates to the map information 1394 may include updates for the HD map 1322, such as information regarding construction sites, potholes, detours, flooding, and/or other obstructions. In some examples, the neural networks 1392, the updated neural networks 1392, and/or the map information 1394 may have resulted from new training and/or experiences represented in data received from any number of vehicles in the environment, and/or based on training performed at a datacenter (e.g., using the server(s) 1378 and/or other servers).

The server(s) 1378 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1390, and/or the machine learning models may be used by the server(s) 1378 to remotely monitor the vehicles.

In some examples, the server(s) 1378 may receive data from the vehicles and apply the data to up-to-date real-time neural networks for real-time intelligent inferencing. The server(s) 1378 may include deep-learning supercomputers and/or dedicated AI computers powered by GPU(s) 1384, such as a DGX and DGX Station machines developed by NVIDIA. However, in some examples, the server(s) 1378 may include deep learning infrastructure that use only CPU-powered datacenters.

The deep-learning infrastructure of the server(s) 1378 may be capable of fast, real-time inferencing, and may use that capability to evaluate and verify the health of the processors, software, and/or associated hardware in the vehicle 1300. For example, the deep-learning infrastructure may receive periodic updates from the vehicle 1300, such as a sequence of images and/or objects that the vehicle 1300 has located in that sequence of images (e.g., via computer vision and/or other machine learning object classification techniques). The deep-learning infrastructure may run its own neural network to identify the objects and compare them with the objects identified by the vehicle 1300 and, if the results do not match and the infrastructure concludes that the AI in the vehicle 1300 is malfunctioning, the server(s) 1378 may transmit a signal to the vehicle 1300 instructing a fail-safe computer of the vehicle 1300 to assume control, notify the passengers, and complete a safe parking maneuver.

For inferencing, the server(s) 1378 may include the GPU(s) 1384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included i wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may utilize distributed file system 1538 for large-scale data processing (e.g., “big data”). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising one or more processing units to:
receive simulation data that at least partially represents one or more portions of an interior of a virtual ego-machine that is a virtual representation of a real-world ego-machine, wherein the one or more portions of the interior of the virtual ego-machine include one or more virtual display devices simulating one or more real-world display devices;
receive first display data generated by a hardware component of the real-world ego-machine; and
based at least on the receiving of the first display data generated by the hardware component of the real-world ego-machine, cause display of the first display data in the virtual representation at the one or more virtual display devices of the virtual ego-machine.

2. The one or more processors of claim 1, wherein the simulation data includes a representation of a natural lighting characteristic corresponding to a source of illumination external to the virtual ego-machine, and wherein the display, at the one or more virtual display devices of the virtual ego-machine, of the first display data, is based at least in part on the representation of the natural lighting characteristic.

3. The one or more processors of claim 1, wherein the simulation data includes a representation of a lighting characteristic according to a placement of a virtual source of illumination within the interior of the virtual ego-machine, and wherein the display, at the one or more virtual display devices of the virtual ego-machine of the first display data is based at least on the representation of the lighting characteristic according to the placement of the virtual source of illumination within the interior the virtual ego-machine.

4. The one or more processors of claim 1, wherein the simulation data includes a representation of a scene configuration outside of the virtual ego-machine, and wherein the one or more processing units are further to:
predict, based on the representation of the scene configuration, virtual sensor data representative of the one or more portions outside of the virtual ego-machine; and
trigger the hardware component to generate real-world video data based at least on processing the virtual sensor data, and wherein the display, at the one or more virtual display devices of the virtual ego-machine, of the first display data includes the real-world video data based at least on the prediction of the virtual sensor data.

5. The one or more processors of claim 1, wherein the one or more processing units are further to:
receive user input made at the one or more virtual display devices that simulate one or more real-world display devices; and
in response to the receiving of the user input, trigger the hardware component to cause the display, at the one or more virtual display devices, of the first display data based at least on the receiving of user input and interpreting the user input as a touch input.

6. The one or more processors of claim 1, wherein the one or more processing units are further to:
receive a user input made at a video game controller; and
in response to the receiving of the user input made at the video game controller, trigger the hardware component to cause the display, at the one or more virtual display devices, of a video game feed that includes the first display data.

7. The one or more processors of claim 1, wherein the one or more processing units are further to:
modify or control, at the one or more virtual display devices of the virtual ego-machine, at least one of, a size, a location, a resolution, screen reflectivity, or a brightness level of the first display data in the virtual representation of the real-world ego-machine based on at least one of, a display capability of the hardware component, a representation of a natural lighting characteristic outside of the virtual ego-machine, a user input at the one or more virtual display devices, or a representation of a lighting characteristic according to a placement of a virtual source of illumination within the interior of the virtual ego-machine.

8. The one or more processors of claim 1, wherein the hardware component includes In-Vehicle Infotainment hardware (IVI), and wherein the one or more virtual display devices simulate a real-world infotainment device of the real-world ego-machine.

9. The one or more processors of claim 1, wherein the simulation data is accessible via one or more augmented or virtual reality devices associated with one or more teams of designers or developers.

10. The one or more processors of claim 1, wherein the simulation data is further representative of at least one of, a user interface design tool for the one or more real-world display devices of the real-world ego-machine or an ego-machine design tool for designing one or more portions of an interior portion of the real-world ego-machine.

11. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processing units to:
receive simulation data representing at least one of, one or more portions of an interior of a virtual ego-machine, one or more portions external to the virtual ego-machine, or a user input associated with one or more virtual display devices, wherein the virtual ego-machine includes the one or more virtual display devices;
transmit the simulation data to one or more network devices to generate, via a hardware component, response data based at least on a mapping of the simulation data into one or more values that are processed by the hardware component, wherein the hardware component is capable of controlling one or more functions of one or more real-world devices of a real-world ego-machine; and
based at least in part on receiving the response data via the hardware component that is capable of controlling the one or more functions of the one or more real-world devices of the real-world ego-machine, cause the one or more virtual display devices of the virtual ego-machine to present first display data.

13. The system of claim 12, wherein the simulation data includes a representation of a natural lighting characteristic outside of the virtual ego-machine, and wherein a display, at the one or more virtual display devices of the virtual ego-machine, of the first display data, is based at least in part on the representation of the natural lighting characteristic.

14. The system of claim 12, wherein the simulation data includes a representation of a lighting characteristic according to a placement of a virtual source of illumination within the interior of the virtual ego-machine, and wherein a display, at the one or more virtual display devices of the virtual ego-machine, of the first display data, is based at least on the representation of the lighting characteristic according to the placement of the virtual light inside the virtual ego-machine.

15. The system of claim 12, wherein the simulation data includes a representation of a scene configuration outside of the virtual ego-machine, and wherein the one or more processing units are further to:
predict, based on the representation of the scene configuration, virtual sensor data representative of the one or more portions external to the virtual ego-machine; and
trigger the hardware component to generate real-world video data based at least on processing the virtual sensor data, and wherein a display, at the one or more virtual display devices of the virtual ego-machine, of the first display data includes the real-world video data based at least on the prediction of the virtual sensor data.

16. The system of claim 12, wherein the one or more processing units are further to:
receive user input made at the one or more virtual display devices that simulate one or more real-world display devices; and
in response to the receiving of the user input, trigger the hardware component to cause display, at the one or more virtual display devices, of the first display data based at least on the receiving of user input and interpreting the user input as a touch input.

17. The system of claim 12, wherein the hardware component includes at least one of, an In-Vehicle Infotainment hardware (IVI) and a cockpit Electric Control Unit (ECU).

18. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
receiving simulation data representing at least one of, one or more portions within a virtual ego-machine, one or more portions external to the virtual ego-machine, or a user input associated with one or more virtual display devices;
transmitting the simulation data to one or more network devices to generate, via a hardware component, response data based at least on a mapping of the simulation data into one or more values that are processed by the hardware component, wherein the hardware component is capable of controlling one or more functions of one or more real-world devices of a real-world ego-machine; and
based at least in part on receiving the response data via the hardware component that is capable of controlling the one or more functions of the one or more real-world devices of the real-world ego-machine, causing display of first display data representing one or more portions of an interior of a virtual ego-machine.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center, or
a system implemented at least partially using cloud computing resources.
